(19) United States
(12) Patent Application Publication
(10) Pub. No.: US 2016/0034693 A1
(43) Pub. Date: Feb. 4, 2016

(54) CERTIFICATE AUTHORITY OPERATION APPARATUS AND METHOD

(71) Applicant: FUJITSU LIMITED, Kawasaki-shi (JP)

(72) Inventor: Takashi Takeuchi, Yokohama (JP)

(21) Appl. No.: 14/738,986

(22) Filed: Jun. 15, 2015

(30) Foreign Application Priority Data
Jul. 30, 2014 (JP) 2014-154658

(51) Int. Cl. G06F 21/60

(52) U.S. Cl. CPC G06F 21/602; G06F 21/604

(57) ABSTRACT

A certificate authority operation apparatus includes a storage unit that retains a plurality of private keys that correspond to a plurality of cryptosystems with different generations, respectively, encryption strength of each of the plurality of cryptosystems being different according with the generations, and a processor which executes a process. The process includes, when acquiring an issuance instruction, performing a control so as to issue a public key certificate by utilizing a first private key that corresponds to a cryptosystem of a generation whose encryption strength is highest.

### CROSS-REFERENCE TO RELATED APPLICATION

This application is based upon and claims the benefit of priority of the prior Japanese Patent Application No. 2014-154658, filed on Jul. 30, 2014, the entire contents of which are incorporated herein by reference.

### FIELD

The present invention relates to a certification technology.

### BACKGROUND

In a PKI (public key infrastructure), security of a digital certificate (public key certificate) and a certificate revocation list is ensured by continuously modifying a cryptographic technology so that it has a sufficient strength, along with improvement in computer performance and research results on cryptanalysis.

A digital certificate (hereinafter referred to as the certificate) is one public key distribution means and is a certificate for certifying that the public key belongs to the user. The certificate is issued by a certificate authority (CA), and includes the public key, identification information for the owner of the private key for the public key, and an electronic signature of the CA. The electronic signature is signature information that is given in order to ensure the legitimacy of the certificate, and is generated, for example, by the CA in the following manner. That is, the CA generates a hash value of the public key by using a specified hash function, encrypts the generated hash value by using the private key of the CA, and generates the electronic signature. The CA ensures the legitimacy of the certificate by means of the electronic signature. An algorithm that is used for generating an electronic signature is referred to as a signature algorithm in the following description. For example, the signature algorithm is obtained by combining a hash algorithm that is used in a hash function and an encryption algorithm that uses a private key. Examples of the hash algorithm include SHA (Secure Hash Algorithm)-1, SHA256, and MD5 (Message Digest Algorithm 5). Examples of the encryption algorithm include RSA (Rivest Shamir Adleman) and ECDSA (Elliptic Curve Digital Signature Algorithm).

Among the certificates, there are certificates for certifying the legitimacy of a CA. A certificate for a CA is for ensuring the legitimacy of the public key of the CA by another CA (by itself in the case of a certificate for a root CA). In the following description, a certificate for certifying the legitimacy of the public key of an end user (user) who uses a CA is referred to as a user certificate and a certificate for the CA is referred to as a CA certificate (certificate authority certificate). Note that the root CA refers to a CA that certifies its legitimacy by itself. The root CA issues a root CA certificate that is a certificate for certificating itself. An intermediate CA is a CA other than the root CA. The intermediate CA certifies its own legitimacy by a higher-level CA.

A certificate revocation list (hereinafter referred to as a revocation list) is a list of certificates that become invalid in a certificate-valid period. A person who judges a validity of a certificate checks the validity of the received certificate by using the revocation list. The revocation list includes an electronic signature of a CA and the CA ensures the legitimacy of the revocation list. The revocation list includes a serial number of the revoked certificate, a revocation date, and a revocation reason, and the like.

There are three types of revocation lists for each piece of listed revocation information, that is, a CRL (Certificate Revocation List), an ARL (Authority Revocation List), and an EPRL (End-entity Public-key Certificate Revocation List). The CRL is a revocation list that includes revocation information on all the certificates that have been issued by the CA and is obtained by combining the ARL and the EPRL. The ARL is a revocation list of only CA certificates that do not include revocation information on user certificates. The EPRL is a revocation list of only the user certificates that do not include revocation information on the CA certificates.

In a case in which the key length of the CA private key or the signature algorithm of a CA is changed into one that corresponds to a new encryption technology, an application (software) that executes a certificate validity judgment (verification) process as well as the CA need to adapt to the change. This is because, since the private key and the signature algorithm that have been used for generating a certificate are also used for the CRL in certificate verification, the verification of the received certificate cannot be confirmed by using the CRL in a case in which the application does not support the new key length of the private key or the new signature algorithm.

Therefore, in migration of the key length of the CA private key or the signature algorithm, adaptation of migration is carried out, for example, in the following order. First, as a preparatory step for the migration, software or hardware of a system including that of a user is sequentially replaced with software or hardware that supports a new encryption technology, and conventional assets such as shared resources of each server and certificates of a user environment are migrated to a new environment. Next, as a migration step, the environments of the user and each server are sequentially shifted into environments that use the new encryption technology, and are set so as to support both old and new encryption technologies. In the migration step, the CA starts issuing a certificate and a revocation list that correspond to the new encryption technology. In this stage, both old and new encryption technologies are used. As a completion step for the migration, use of the conventional encryption technology is suspended. That is, settings are changed so that the old certificates are revoked and deleted from all the products and so that the conventional encryption technology is not used.

In the migration step, a migration period is generated in which operations of certificates that use an old-generation key and operations of certificates that use a new-generation key are mixed. In a large-scale system, migration in a short period is difficult. For example, in the case of SHA-1, in which degradation of the encryption technology is mild and risk progress is slow, the migration step might be initiated before the preparatory step has been completed. One reason for the migration step to be initiated before the preparatory step has been completed is that the old and new certificates are swapped before expiration of the valid period in accordance with a normal operation because waiting for depreciation and waiting for development of a successor product and a migration tool are given priority.

In contrast, there is a first technology that enables one CA to issue digital certificates to which a plurality of signature schemes are applied.

A system according to the first technology includes a CA that issues a digital certificate of an entity that uses the digital certificate, and a registration authority (RA) that transmits to the CA a digital certificate issuance request that is received from a jurisdiction entity. The CA has a plurality of signature modules which each carry out different signature schemes. The CA selects one signature module from among the plurality of signature modules according to the digital certificate issuance request from the RA, and gives an electronic signature for message data that constitutes the digital certificate in the selected signature module.

Techniques that are described in the following documents are known.

Japanese Laid-open Patent Publication No. 2002-207426

### SUMMARY

According to an aspect of the embodiment, a certificate authority operation apparatus includes a storage unit that retains a plurality of private keys that correspond to a plurality of cryptosystems with different generations, respectively, encryption strength of each of the plurality of cryptosystems being different according with the generations, and a processor which executes a process. The process includes, when acquiring an issuance instruction, performing a control so as to issue a public key certificate by utilizing a first private key that corresponds to a cryptosystem of a generation whose encryption strength is highest.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional diagram illustrating a configuration of an example of a CA operation apparatus according to an embodiment;

FIG. 2 illustrates an example of the configuration of a certification system according to the embodiment;

FIG. 3A illustrates an example of the configuration of CA management information;

FIG. 3B illustrates an example of setting information for each type of a revocation list;

FIG. 4 illustrates an example of certificate management information;

FIG. 5 illustrates an example of revocation list management information;

FIG. 6 illustrates an example of strength information;

FIG. 7 is a diagram illustrating a state when a Push type verification application refers to a revocation list in a case in which lists of invalid certificates that are listed on the revocation list are not brought together;

FIG. 8 is a diagram illustrating a state when the Push type verification application refers to a revocation list in a case in which lists of invalid certificates that are listed on the revocation list are brought together;

FIG. 9 is a diagram illustrating a state when a Pull type verification application refers to a revocation list in a case in which lists of invalid certificates that are listed on the revocation list are not brought together;

FIG. 10 is a diagram illustrating a state when the Pull type verification application refers to a revocation list in a case in which lists of invalid certificates that are listed on the revocation list are brought together;

FIG. 11 is an example of the application screen that is used when a CA manager inputs a revocation list issuance stop request;

FIG. 12 is an example of the application screen that is used when the CA manager inputs revocation list type settings;

FIG. 13 is an example of the application screen that is used when the CA manager inputs a revocation list search request;

FIG. 14 is an example of a flowchart illustrating details of a CA certificate issuance process in a root CA;

FIG. 15 is an example of an application screen that is used when the CA manager inputs a CA certificate issuance instruction in the root CA;

FIG. 16 is an example of a flowchart illustrating details of a CA certificate issuance process in an intermediate CA;

FIG. 17 is an example of an application screen that is used when the CA manager inputs a CA certificate issuance instruction or registers an intermediate CA certificate in the intermediate CA;

FIG. 18 is an example of a flowchart illustrating details of a user certificate issuance process in case 1;

FIG. 19 is an example of a flowchart illustrating details of a user certificate issuance process in case 2 and case 3;

FIG. 20 is an example of a flowchart illustrating details of a certificate revocation process;

FIG. 21 is an example of a flowchart (former part) illustrating details of a revocation list issuance process;

FIG. 22 is an example of a flowchart (latter part) illustrating details of the revocation list issuance process;

FIG. 23 is an example of a flowchart illustrating details of a revocation list output destination overlap avoidance control process; and

FIG. 24 illustrates a hardware configuration of the CA operation apparatus according to the embodiment.

### DESCRIPTION OF EMBODIMENTS

Management of certificates which correspond for each keys of multiple generations in the migration period leads to an increase in security risk. This is because certificates that use old-generation keys whose strength has been degraded are issued.

According to an embodiment, security risks can be reduced in the CA operation apparatus that corresponds to a plurality of cryptosystems that use private keys of multiple generations.

In an embodiment, it is assumed that a cryptosystem refers to one of or any combination of a CA private key, the key length of the CA private key, and a signature algorithm, which are used when a CA generates an electronic signature. That is, it is assumed that “changing a cryptographic technology” refers to one of or a specified combination of changing the CA private key, changing the CA private key after changing the key length of the CA private key, and changing the signature algorithm of the CA. In the following description, the newest cryptosystem after migration may be referred to as the newest generation, and cryptosystems older than that may be collectively referred to as an old generation.

When changing the cryptosystem, the CA reissues a CA certificate after updating the CA private key of the old generation to a CA private key of a new generation, updating the CA private key after extending the key length, or changing the signature algorithm. At that time, leaving the private key of the old generation as it is so that the CA may use it poses a security risk. This is because since the key strength deteriorates over time, continuous use of the old generation key whose strength has been reduced cannot avoid a security risk. In addition, when one CA issues certificates or revocation lists by using a plurality of private keys, corresponding certificates have to be managed in units of keys, which is the same as multiple operations of the same CA. Furthermore, it takes a greater process time for an application for judging the validity of a certificate (hereinafter referred to as a verification application) to verify the validity of the certificate because the number of certification paths to be searched for increases or communication traffic increases.

Thus, in a case in which the cryptosystem is changed, the CA according to the embodiment stops issuing a certificate that uses a cryptosystem of the old generation (hereinafter referred to as a certificate of the old generation) once operation of the cryptosystem of the new generation is started. Since issuance of a certificate that has been generated by using an old generation key whose strength has been deteriorated is stopped, security risks may be reduced. Since it is no longer need to manage certificates that are newly generated by using the cryptosystem of the old generation, security risks may be reduced and management costs may be reduced.

Note that the CA continues to issue a revocation list that has been signed by using the cryptosystem of the old generation (hereinafter referred to as a revocation list of the old generation) until a migration period has been completed. This is because a verification application that supports only the cryptosystem of the old generation (signature algorithm of the old generation and key length of the CA private key of the old generation) is unable to use a revocation list of the cryptosystem of the new generation (hereinafter referred to as a revocation list of the new generation), and is able to use only a revocation list of the old generation. That is, the cryptosystem of the embodiment may continue to use the certificate of the old generation that has been issued so far by using the verification application of the old generation while reducing security risks that are posed by issuing a certificate of the old generation.

The CA according to the embodiment collectively includes in the revocation list of the new generation revocation information on certificates of the old generation in addition to revocation information on certificates that uses the cryptosystem of the new generation (hereinafter referred to as certificates of the new generation). Therefore, the verification application of the new generation may only refer to the revocation list of the new generation in order to verify the validity of both the certificate of the new generation and the certificate of the old generation. As described, there is no need to change the revocation list to be referred to depending on whether the certificate is the certificate of the old generation or the certificate of the new generation, and a load involved in validity verification may be reduced.

Since the CA according to the embodiment may manage cryptosystems of multiple generations by itself, an operational load and costs may be further reduced in comparison with the case of operating a plurality of certificate authorities in parallel.

In addition, the CA according to the embodiment is cost-effective. In a case in which a plurality of certificate authorities are operated in parallel, in a CA operation apparatus that manages the cryptosystem of the old generation, an end of service life of software or hardware might occur during the migration period, or a failure might occur due to long-term operation. Since the CA operation apparatus of the old generation is no longer used once the migration period is completed, it is not cost-effective to repair the CA operation apparatus when it fails or to update the system in case it fails. In contrast, the CA of the embodiment is continuously used after completion of the migration period, and therefore is more effective.

The CA according to the embodiment may simultaneously issue a plurality of old and new revocation lists whose cryptographic technologies are different from one other. Therefore, it is possible to verify a certificate by using the verification application of the old generation until migration of the cryptographic technology has been completed. Furthermore, it is possible to associate permission for issurance of the revocation list of each generation with one another according to a strength of the cryptographic technology or security level of each CA.

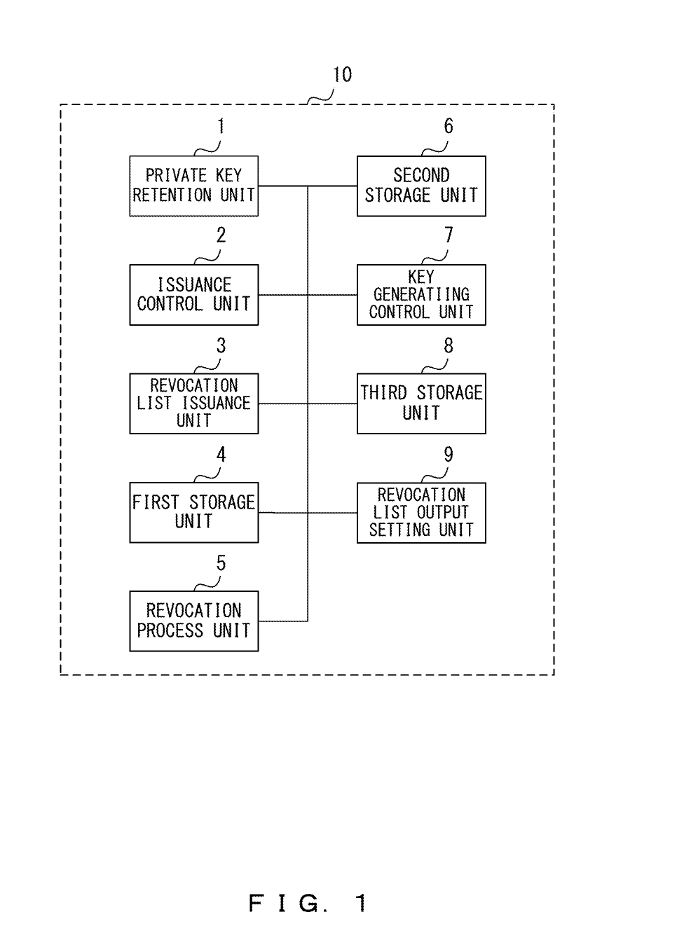

FIG. 1 is a functional block diagram illustrating a configuration of an example of a CA operation apparatus 10 according to the embodiment. In FIG. 1, the CA operation apparatus 10 includes a private key retention unit 1, an issuance control unit 2, a revocation list issuance unit 3, a first storage unit 4, a revocation process unit 5, a second storage unit 6, a key generating control unit 7, a third storage unit 8, and a revocation list output setting unit 9.

The private key retention unit 1 retains a plurality of private keys that correspond to a plurality of cryptosystems with different generations, respectively. Encryption strength of each of the plurality of cryptosystems is different according with the generations.

In a case in which the issuance control unit 2 acquires an issuance instruction, the issuance control unit 2 performs a control so as to issue a public key certificate by utilizing a first private key that corresponds to a cryptosystem of a generation whose encryption strength is highest.

In addition, the issuance control unit 2 performs a control so as to issue the public key certificate by utilizing the first private key that corresponds to a cryptosystem of a latest generation among the cryptosystems of the plurality of generations and so as not to issue a public key certificate by utilizing a second private key that is different from the first private key

The revocation list issuance unit 3 issues, by utilizing a private key from among the plurality of private keys, a revocation list that includes revocation information on a public key certificate that has been issued by utilizing the private key from among the plurality of private keys.

In addition, the revocation list issuance unit 3 stops the issuance of a revocation list of the public key certificate that has been issued by utilizing the private key when acquiring an issuance stop request for the revocation information.

A revocation list that has been generated by utilizing the cryptosystem of the generation whose encryption strength is highest includes revocation information on a public key certificate that has been issued by utilizing a cryptosystem of a generation that is different from the generation whose encryption strength is highest

The first storage unit 4 stores generation information that is obtained by associating information that indicates a generation of the cryptosystem with a public key certificate that has been generated by utilizing a cryptosystem of a generation that is indicated by the information that indicates the generation.

when a CA certificate that is a public key certificate for ensuring legitimacy of the CA operation apparatus 10 has been revoked, the revocation process unit 5 revokes a CA certificate that has been generated by utilizing a cryptosystem whose encryption strength is weaker than a cryptosystem that has been used for generating the revoked CA certificate according to the generation information.

The second storage unit 6 stores information that indicates each strength of the plurality of private keys.

The key generating control unit 7, when the first private key is generated, in a case in which a strength of the first private key is higher than strengths of any of private keys that are different from the first private key, performs a control so as to generate the first private key.

The third storage unit 8 stores output destination information that indicates each output destination of the plurality of revocation lists.

when the revocation list output destination unit 9 receives a setting request that includes a first output destination that indicates an output destination of a first revocation list that is a revocation list among the plurality of revocation lists, the revocation list output destination unit 9 sets as the first output destination the output destination of the first revocation list in a case in which the first output destination that is included in the received setting request is different from an output destination that is indicated by the output destination information of a revocation list whose generation is different from that of the first revocation list.

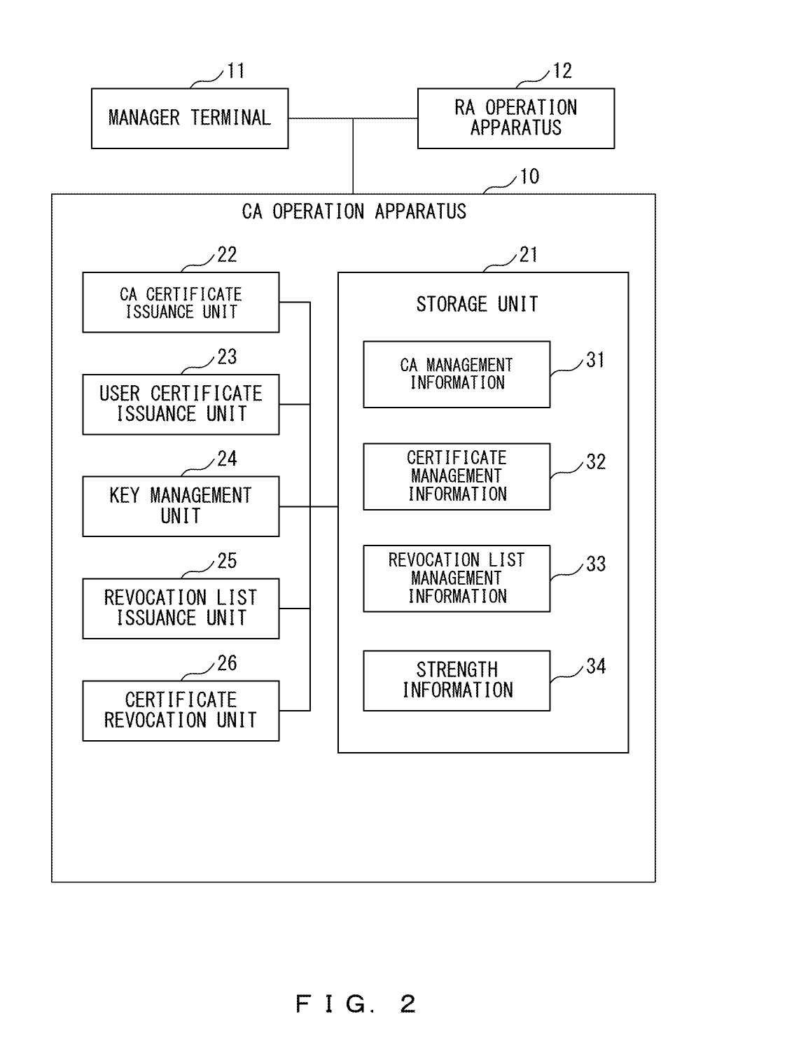

FIG. 2 illustrates an example of a certification system according to the embodiment. In FIG. 2, the certification system includes the CA operation apparatus 10, a manager terminal 11, and a RA operation apparatus 12. The CA operation apparatus 10, the manager terminal 11, and the RA operation apparatus 12 are connected with one another, for example, via a communication network.

The manager terminal 11 transmits a user certificate issuance request to the RA operation apparatus 12, and receives a user certificate from the RA operation apparatus 12. The manager terminal 11 may transmit a user certificate issuance request directly to the CA operation apparatus 10 and may receive the user certificate from the CA operation apparatus 10. Note that in the user certificate issuance request, the manager terminal 11 may prepare a user certificate issuance application form (CSR (Certificate Signing Request)) and transmit it as an issuance request, or may request that the issuance request destination device prepare the CSR. When the manager terminal 11 verifies the legitimacy of a public key certificate, the manager terminal 11 requests that via, for example, a verification application, the CA operation apparatus 10 issue a revocation list.

The RA operation apparatus 12 receives a user certificate issuance request from the manager terminal 11 and transmits the user certificate issuance request to the CA operation apparatus 10. In a case in which an CSR has been transmitted as the user certificate issuance request from the manager terminal 11, the RA requests user certificate issuance by transmitting the received CSR to the CA operation apparatus 10. In a case in which the CSR is not included in the user certificate issuance request from the manager terminal 11, the RA operation apparatus 12 generates a pair of a private key and a public key that are used by a user, prepares a user certificate CSR (PKCS#10), and transmits it to the CA operation apparatus 10. Thereafter, the RA operation apparatus 12 outputs the user certificate from the CA operation apparatus 10, and transmits to the manager terminal 11 only the received user certificate (PKCS#7) or the certificate together with the private key (PKCS#12 format).

The CA operation apparatus 10 issues a public key certificate and a revocation list.

The CA operation apparatus 10 includes a storage unit 21, a CA certificate issuance unit 22, a user certificate issuance unit 23, a key management unit 24, a revocation list issuance unit 25, and a certificate revocation unit 26. The storage unit 21 is an example of the first storage unit 4, the second storage unit 6, and the third storage unit 8. The CA certificate issuance unit 22 and the user certificate issuance unit 23 are examples of the issuance control unit 2. The key management unit 24 is an example of the private key retention unit 1. The revocation list issuance unit 25 is an example of the revocation list issuance unit 3 and the revocation list output setting unit 9. The certificate revocation unit 26 is an example of the revocation process unit 5. The CA certificate issuance unit 22 is an example of the key generating control unit 7.

The storage unit 21 stores CA management information 31, certificate management information 32, revocation list management information 33, and strength information 34.

The CA management information 31 is information for storing in association with one another each CA certificate that has been issued by the CA operation apparatus 10, a cryptosystem that corresponds to the CA certificate, and information on the revocation list that has been issued by using the cryptosystem.

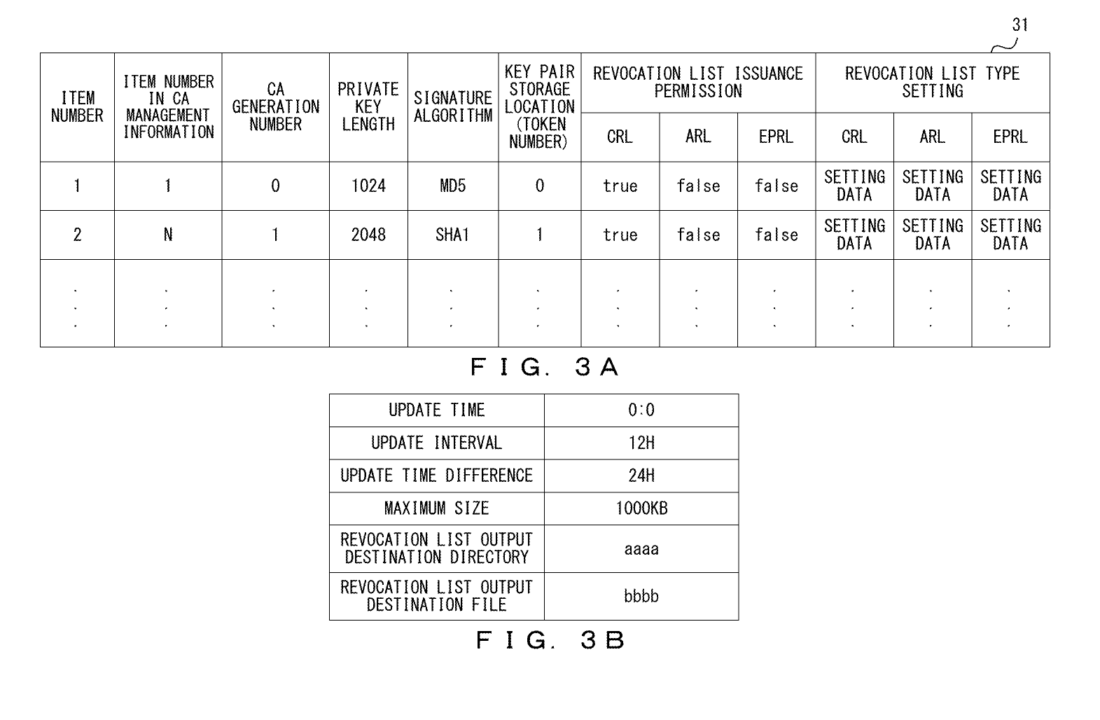

FIG. 3A illustrates an example of the configuration of the CA management information 31. The CA management information 31 stores in association with one another the data items “item number”, “item number in certificate management information”, “CA generation number”, “private key length”, “signature algorithm”, “key-pair storage location”, “revocation list issuance permission”, and “revocation list type setting”.

“Item number” is a management number for managing each record of the CA management information 31. It is assumed that values of “item number” increase in ascending order in order of adding records. Each record in the CA management information 31 is added sequentially when a CA certificate is issued or updated, and the new issued or updated certificate itself is managed in the certificate management information 32.

“Item number in certificate management information” is information that indicates “item number” in the certificate management information 32 and is information for linking information related to each certificate, which is managed in the certificate management information 32. In the certificate management information 32, management information that indicates certificate data and the owner and the issuer of the certificate are stored for each certificate. The certificate management information 32 will be described later in detail. Note that “item number in certificate management information” may be specifically, for example, information that indicates a pointer to a storage location in which a certificate is stored (for example, a token in PKCS#11).

“CA generation number” is information that indicates the CA generation number of a CA. The CA generation number is newly assigned in a case in which the CA manager decides to update the CA generation number when the CA certificate is issued or updated or a CA certificate is issued by using a private key whose key length has been changed or a new signature algorithm.

“Private key length” is the number of patterns that a private key that corresponds to a CA certificate may take, and for example is expressed by a bit length when the number of patterns of the private key is expressed in binary.

“Signature algorithm” is identification information for uniquely identifying the signature algorithm that corresponds to a CA certificate. As described above, the signature algorithm is expressed in the combination of the encryption algorithm of a private key and a hash algorithm. The signature algorithm that corresponds to a CA certificate refers to a signature algorithm that has been used for issuing the CA certificate.

“Key-pair storage location” is information that indicates the storage location in which data of the public key and the private key that correspond to a CA certificate is stored. Specifically, “key-pair storage location” may be, for example, a pointer to an address (for example, token number in PKCS#11) that indicates the area in which the data of the private key is stored. The private key that corresponds to a CA certificate refers to the private key that has been used for issuing the CA certificate.

“Revocation list issuance permission” is information that indicates whether or not to permit issuance of a revocation list that has been signed by using the corresponding “signature algorithm” and the corresponding private key that is stored in “key-pair storage location”. “Revocation list issuance permission” is set for each revocation list type. Note that as described above, there are three revocation list types, that is, the CRL, the ARL, and the EPRL.

“Revocation list type setting” is detailed setting information for each type of the revocation list that has been signed by using the corresponding “signature algorithm” and the corresponding private key that is stored in “key-pair storage location”.

FIG. 3B illustrates an example of setting information for each revocation list type. In FIG. 3B, setting items of “revocation list type setting” include the data items “update time”, “update interval”, “update time difference”, “maximum size”, “revocation list output destination directory”, and“revocation list output destination file”. “Update time” is information that indicates a revocation list update time. “Update interval” is information that indicates revocation list update intervals. “Update time difference” is information that indicates a time difference between the time when the revocation list has been updated and the time when the revocation list has actually been released. “Maximum size” is information that indicates the maximum size of the revocation lists. “Revocation list output destination directory” is information that indicates the output destination directory (folder) of the revocation list. “Revocation list output destination file” is information that indicates the file name of the revocation list output destination.

The certificate management information 32 is information for associating data of a certificate, management information on the certificate, and a CA generation number with one another and stores them. Here, a certificate that is managed in the certificate management information 32 includes both a CA certificate and a user certificate.

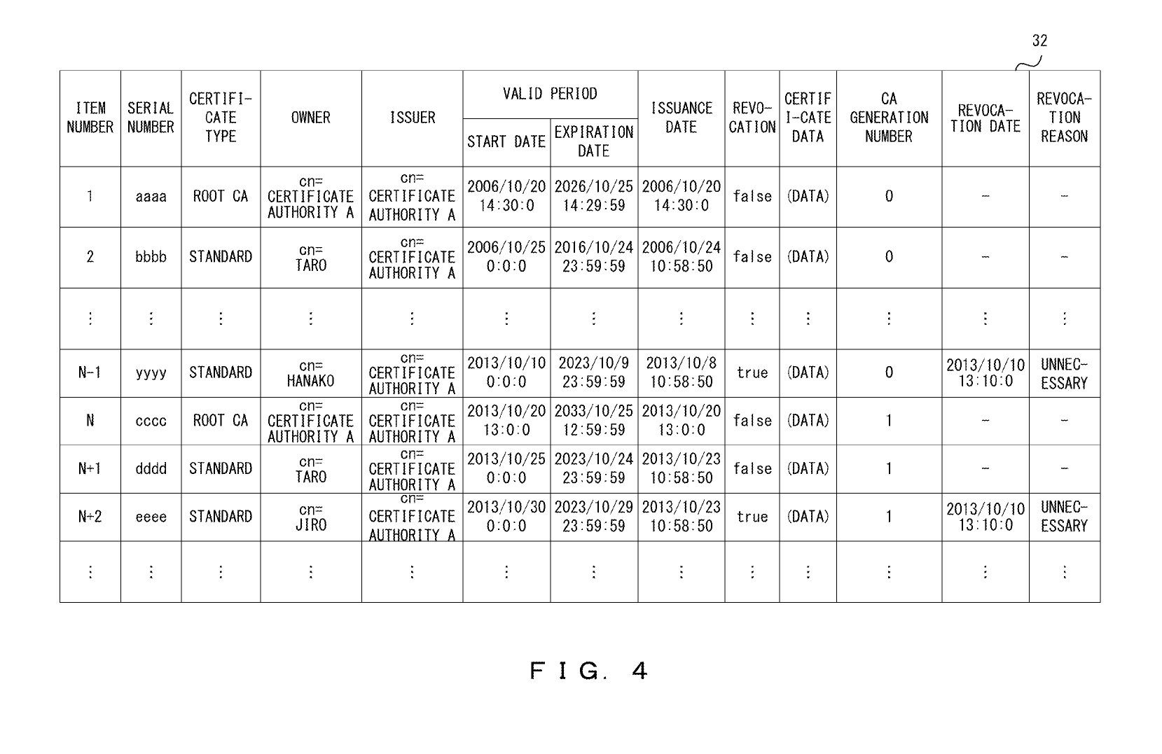

FIG. 4 illustrates an example of the certificate management information 32. In the certificate management information 32, “item number”, “serial number”, “certificate type”, “owner”, “issuer”, “valid period”, “issuance date”, “revocation”, “certificate data”, “CA generation number”, “revocation date”, and “revocation reason” are stored in association with one another.

“Item number” is a management number for uniquely identifying each record in the certificate management information 32. It is assumed that the values of “item number” increase in ascending order of adding records. Each record of the certificate management information 32 is generated in association with each certificate.

“Serial number” is a serial number for a certificate and is a certificate preparation number in the CA operation apparatus 10.

“Certificate type” is identification information for uniquely identifying a certificate type. For example, the certificate types include a root CA certificate, an intermediate CA certificate, and a user certificate. In the example illustrated in FIG. 4, “root CA” indicates the root CA certificate, and “standard” indicates the user certificate. Note that it is assumed that “intermediate CA” (not shown) indicates the intermediate CA certificate.

“Owner” is information that indicates the owner of a certificate. Information that indicates the owner is identification information that includes one or all of, for example, a country name, an organization name, an owner's name, an ID, and an email address. Note that in a case in which “certificate type” is information that indicates a root CA certificate, information on “owner” and that on “issuer” match each other.

“Issuer” is information that indicates a CA that has issued a certificate. Information that indicates the CA that has issued the certificate is information that includes one or all of, for example, a country name, an organization name, and a CA name.

“Valid period” is information that indicates the valid period of a certificate. “Valid period” further includes the data items “start date” and “expiration date”. “Start date” is information that indicates the start date of the certificate valid period. “Expiration date” is information that indicates the expiration date of the certificate valid period.

“Issuance date” is information that indicates a certificate issuance date.

“Revocation” is information that indicates whether or not a certificate has been revoked. In the example illustrated in FIG. 4, “false” indicates that a certificate has not been revoked, and “true” indicates that a certificate has been revoked.

“Certificate data” is data of a certificate itself.

“CA generation number” is information that indicates the CA generation number of the CA operation apparatus 10 when a certificate is issued, and is information that corresponds to “CA generation number” in the CA management information 31. This “CA generation number” indicates that a certificate has been issued by using the “signature algorithm” and the private key of “private key length” that correspond to the CA certificate of “CA generation number”.

“Revocation date” is information that indicates the date when a certificate was revoked. In the example illustrated in FIG. 4, in a case in which a certificate is not revoked (“revocation” is “false”), “-” is stored in “revocation date”, and in a case in which a certificate has been revoked (“revocation” is “true”), the date when the certificate was revoked is stored in “revocation date”.

“Revocation reason” is information that indicates the reason why a certificate has been revoked. In the example in FIG. 4, in a case in which a certificate has not been revoked (“revocation” is “false”), “-” is stored in “revocation reason”. In a case in which a certificate has been revoked (“revocation” is “true”), the revocation reason is stored in “revocation reason”.

Note that each value of “serial number”, “certificate type”, “owner”, “issuer”, “valid period”, “issuance date”, “revocation”, “certificate data”, “CA generation number”, “revocation date”, and “revocation reason” is information on a certificate that is associated with the corresponding “item number”. In addition, information such as “serial number”, “owner”, “issuer”, and “valid period” is also stored in the certificate itself.

The revocation list management information 33 is information for storing data of a revocation list, management information on the revocation list, and a CA generation number in association with one another.

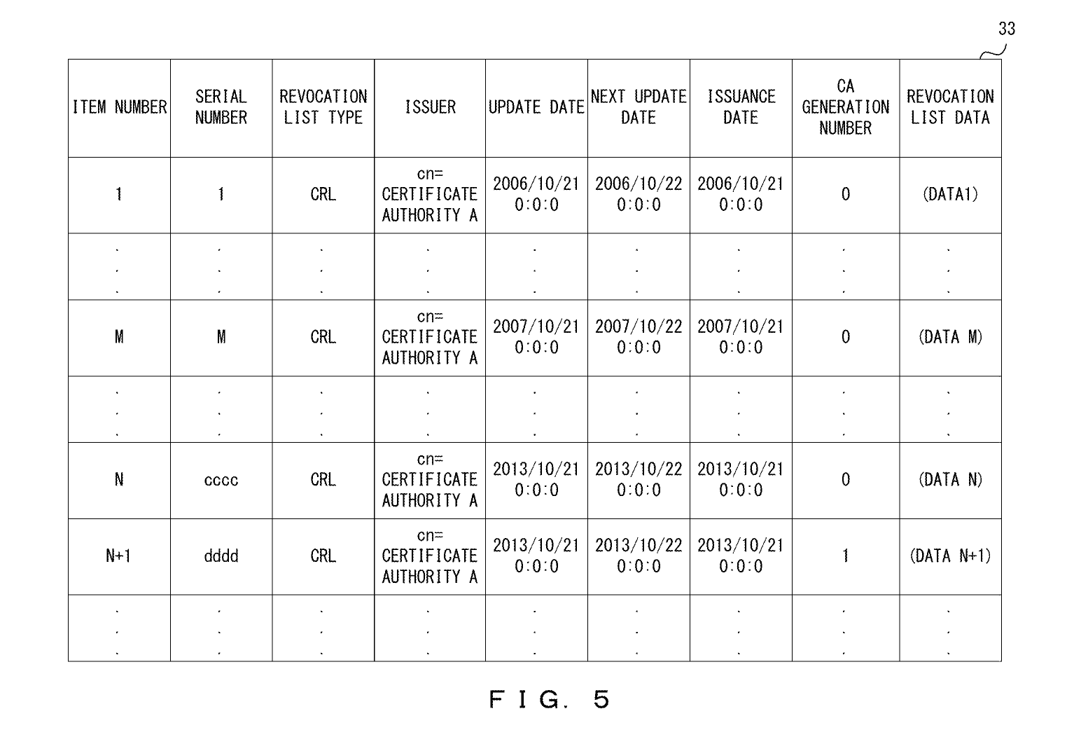

FIG. 5 illustrates an example of the revocation list management information 33. In FIG. 5, in the revocation list management information 33, data items, “item number”, “serial number”, “revocation list type”, “issuer”, “update date”, “next update date”, “issuance date”, “CA generation number”, and “revocation list data” are stored in association with one another.

“Item number” is a management number for uniquely identifying each record in the revocation list management information 33. It is assumed that the values of “item number” increase in ascending order in order of adding records. Each record in the revocation list management information 33 is generated in association with each revocation list.

“Serial number” is a serial number for a revocation list and is a revocation list preparation number in a CA.

“Revocation list type” is identification information for uniquely identifying a revocation list type. As described above, there are three revocation list types, that is, the CRL, the ARL, and the EPRL.

“Issuer” is information that indicates a CA that has issued a revocation list. Information that indicates the CA that has issued the revocation list is identification information that includes one or all of, for example, a country name, an organization name, and a CA name.

“Update date” is information that indicates the date when a revocation list was updated.

“Next update date” is information that indicates the date when a revocation list will next be updated.

“Issuance date” is information that indicates when a revocation list was issued.

“CA generation number” is information that indicates the CA generation number of the CA that has issued a revocation list, and is information that corresponds to “CA generation number” in the CA management information 31. “CA generation number” indicates that the revocation list has been issued by using “signature algorithm” and the private key of “private key length” that correspond to the CA certificate of the “CA generation number”.

“Revocation list data” is data of a revocation list itself.

Note that each value of “serial number”, “revocation list type”, “issuer”, “update date”, “next update date”, “issuance date”, “CA generation number”, and “revocation list data” is information on a revocation list that is associated with the corresponding “item number”.

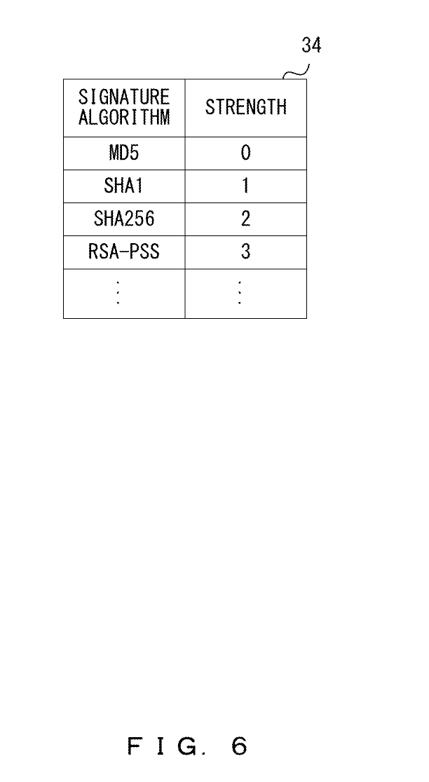

In the strength information 34, a signature algorithm and information that indicates the strength of the signature algorithm are stored in association with each other. FIG. 6 illustrates an example of the strength information 34. In FIG. 6, the data items “signature algorithm” and “strength” are stored in the strength information 34 in association with each other.

“Signature algorithm” is identification information for identifying a signature algorithm.

“Strength” is information that indicates the strength of the encryption algorithm that is presented in the corresponding “signature algorithm”. The example in FIG. 6 indicates that the strength becomes greater as the value of “strength” becomes greater.

In the following description, a private key that corresponds to the latest CA certificate is referred to as a new key, and a private key other than the new key is referred to as an old key. Note that it is assumed that instructions and information from the CA manager is acquired, for example, via a specified input and output device.

The CA certificate issuance unit 22 performs a control related to issuance of a CA certificate. That is, when the CA certificate issuance unit 22 receives a new CA certificate issuance instruction from the CA manager, the CA certificate issuance unit 22 first performs a control for generating a CA private key that is applied to a CA certificate to be newly issued and a public key that corresponds to the private key. Next, the CA certificate issuance unit 22 executes a CA certificate issuance process. Then, the CA certificate issuance unit 22 executes a recording process for recording information on the issued CA certificate, and in a case in which a new key pair is generated, information on the generated key pair.

In a key pair generating control, in a case in which a new key pair generating instruction is included in a CA certificate issuance instruction from the CA manager, the CA certificate issuance unit 22 transmits the new key pair generating instruction to the key management unit 24. At that time, the CA certificate issuance unit 22 performs a control so that the strength of the new key pair to be generated is greater than or equal to that of the old key. Specifically, the CA certificate issuance unit 22 refers to the CA management information 31 before giving the new key pair generating instruction, and compares the strength of the signature algorithm that has been specified in the issuance instruction and that of the signature algorithm of the CA certificate that has been generated most recently. At the same time, the CA certificate issuance unit 22 refers to the CA management information 31, and compares the key length of the private key that has been specified in the issuance instruction and that of the private key that corresponds to the CA certificate that has been issued most recently. In a case in which the CA certificate issuance unit 22 judges that the strength of the algorithm and the key length that have been specified in the issuance instruction are greater than or equal to the strength of the algorithm and the key length of the CA certificate that has been generated most recently, the CA certificate issuance unit 22 transmits a new key generating instruction. Thus, the CA certificate issuance unit 22 may perform a new key generating control so that the strength of the encryption algorithm of a new key is greater than or equal to that of the old key and the key length of the new key is greater than or equal to that of the old key.

The new key generating instruction includes information on the signature algorithm and the key length of the private key that have been specified from the CA manager. The information on the signature algorithm includes, for example, the name (identification information) of the signature algorithm that is used when the CA certificate is issued.

In the comparison in strength between the new key and the old key, the CA certificate issuance unit 22 first acquires information on the signature algorithm and the key length of the new key that have been specified by the CA manager, and then refers to the CA management information 31 and confirms the signature algorithm and the key length of the private key of the CA certificate that has been issued most recently. For example, the CA certificate issuance unit 22 refers to the “private key length” and “signature algorithm” columns of the record in the CA management information 31 whose value of “item number” is greatest among the records whose “certificate type” is a root CA, and recognizes the key length of the private key and the signature algorithm that correspond to the CA certificate that has been generated most recently.

Next, the CA certificate issuance unit 22 confirms, by referring the strength information 34, the strength of the signature algorithm that has been specified in the issuance instruction and the strength of the signature algorithm that corresponds to the CA certificate that has been generated most recently. Then, the CA certificate issuance unit 22 compares the strength of the signature algorithm and the key length of the private key that have been specified in the issuance instruction and the strength of the signature algorithm and the key length of the private key of the CA certificate that has been issued most recently.

When the CA certificate issuance unit 22 judges that the strength of the signature algorithm and the key length of the private key that have been specified in the issuance instruction are greater than or equal to the strength of the signature algorithm and the key length of the private key of the CA certificate that has been issued most recently, the CA certificate issuance unit 22 executes the following process. That is, the CA certificate issuance unit 22 instructs the key management unit 24 to generate a new key pair that has the key length that has been specified in the issuance instruction. The key pair generating instruction includes information that specifies the key length and information that specifies a public key algorithm (RSA, etc.), which is a key generating method.

Thereafter, the CA certificate issuance unit 22 receives as a response to the key pair generating instruction information that indicates that the key pair has been generated, and information (token number) that indicates a storage location (token) of the generated key pair.

In contrast, when the CA certificate issuance unit 22 judges that the strength of the signature algorithm and the key length of the private key that have been specified in the issuance instruction is less than the strength of the signature algorithm and the key length of the private key of the CA certificate that has been issued most recently, the CA certificate issuance unit 22 does not give an instruction to generate a new key. In that case, a specified error process is executed such as displaying on a specified output device a message that a key cannot be generated due to insufficient key strength.

In a CA certificate issuance control, a process will be different depending on whether the CA that executes the process is a root CA or an intermediate CA.

In the case of the root CA, when the CA manager instructs the CA certificate issuance unit 22 to generate a new key pair, the CA certificate issuance unit 22 instructs the key management unit 24 to generate the new key pair, and prepares a CA certificate that includes a newly generated public key after receiving the response from the key management unit 24. Then, the CA certificate issuance unit 22 issues a CA certificate by again instructing the key management unit 24 to give an electronic signature by using the signature algorithm that has been specified by the CA manager and by using a newly generated private key.

In contrast, in a case in which there are no instructions to generate a new key pair, the CA certificate issuance unit 22 refers to the CA management information 31, specifies the latest CA certificate that has been issued most recently, acquires from the key management unit 24 the CA public key that has been stored in the “key-pair storage location” for the CA certificate, and prepares a CA certificate. Then, the CA certificate issuance unit 22 instructs the key management unit 24 to give an electronic signature to the CA certificate by using the signature algorithm that has been specified by the CA manager. Specifically, the CA certificate issuance unit 22 selects the entry in the CA management information 31 whose “item number” is greatest from among the entries whose “certificate type” is root CA, and acquires the values of “signature algorithm” and “key-pair storage location” columns of the selected entry. Then, the CA certificate issuance unit 22 prepares the CA certificate by including therein the acquired values of “signature algorithm” and “key-pair storage location”, the CA public key that has been taken out from the “key-pair storage location”, and information for identifying the CA, and transmits to the key management unit 24 an instruction to sign the CA certificate. Note that the CA public key that is included in the instruction to sign the CA certificate is the CA public key that is paired with the CA private key that corresponds to the latest CA certificate.

As described, by performing a control so that the most recently generated private key serves as the CA private key that is used when a CA certificate is issued, it is possible to perform a control so as not to issue a CA certificate by using an old key. In addition, by using as the signature algorithm that is used in an issuance (electronic signature) of the CA certificate the signature algorithm that corresponds to the latest CA certificate, it is possible to perform a control so that a CA certificate is issued by using the signature algorithm that has the greatest encryption strength. Since a CA certificate that uses a cryptographic technology of an old generation is not issued, it is possible to reduce security risks.

When the instruction to sign the CA certificate has been transmitted, the CA certificate issuance unit 22 receives from the key management unit 24 the CA certificate as a response to the instruction.

In contrast, in the case of the intermediate CA, the CA certificate issuance unit 22 gives via a file a CA certificate issuance instruction (issuance request) to a higher-level CA. In a case in which the CA manager instructs the CA certificate issuance unit 22 to generate a new key pair, the CA certificate issuance unit 22 receives from the key management unit 24 the response to the key pair generating instruction, and then acquires a newly generated CA public key from the key management unit 24, prepares a CA certificate CSR that includes the CA public key, and applies for issuance to the higher-level CA.

Note that the issuance instruction to be given to the higher-level CA is given specifically by causing the higher-level CA to load an CSR file of the CA certificate that has been prepared by the CA certificate issuance unit 22. The CSR includes identification information and the CA public key, etc. for the CA certificate. In contrast, when there are no instructions to generate a new key pair, the CA certificate issuance unit 22 acquires from the key management unit 24 the CA public key that is stored in “key-pair storage location (token number)” of the CA certificate that is the entry whose “certificate type” is intermediate CA and “item number” is greatest in the CA management information 31, and prepares the CA certificate CSR. Then, the CA certificate CSR is provided to the higher-level CA as a file. When an intermediate CA certificate is issued by the higher-level CA, the CA certificate issuance unit 22 receives the CA certificate as an input file.

In the recording process, the CA certificate issuance unit 22 first allocates a CA generation number to a newly issued CA certificate. The CA generation number is incremented in a case in which the signature algorithm that corresponds to the newly issued CA certificate is changed from the signature algorithm that corresponds to the CA certificate that has been issued before (most recently), or in a case in which the key length of the private key that corresponds to the newly issued CA is changed from the key length of the private key that corresponds to the CA certificate that has been issued before (most recently). In this manner, the CA generation number that is allocated to the newly issued CA certificate is greater than by one or equal to the CA generation number of the CA certificate that has been issued most recently. In addition, the CA generation number of the CA certificate that corresponds to the new (greater strength) signature algorithm or the new (greater key length) private key is greater than the CA generation number of the CA certificate that corresponds to the old (smaller strength) signature algorithm or the old (smaller key length) private key. As described, in a case in which the signature algorithm or the key length of the private key has been changed, by changing the CA generation number and by allocating the changed number to a CA certificate, it is possible to control bringing together of information that is listed on a revocation list, which will be described later, for each cryptographic technology that is used when the revocation list is issued. Note that whether or not to increment the CA generation number may be instructed from the CA manager when a CA certificate is issued.

When the CA generation number has been allocated, the CA certificate issuance unit 22 records in the CA management information 31 information that is obtained by associating the newly issued CA certificate and the CA generation number that has been allocated to the CA certificate. In addition, the CA certificate issuance unit 22 records in the certificate management information 32 the newly issued CA certificate in association with the CA generation number that has been allocated to the CA certificate. Furthermore, the CA certificate issuance unit 22 records in the CA management information 31 information that is obtained by associating the newly issued CA certificate with the private key that corresponds to the CA certificate. In a case in which a new key is generated, the CA certificate issuance unit 22 stores in a specified storage area the public key that corresponds to the generated CA private key.

Specifically, the CA certificate issuance unit 22 adds a new entry to the certificate management information 32, and stores in each data item of the entry information on the newly issued CA certificate. At that time, the certificate generation number that has been allocated to the CA certificate is stored in “CA generation number” in the certificate management information 32.

In addition, the CA certificate issuance unit 22 adds a new entry to the CA management information 31 and stores in each data item of the entry information on the newly issued CA certificate and the private key of the CA certificate. Specifically, the CA certificate issuance unit 22 adds a new entry to the CA management information 31, and stores a value in each of “item number”, “item number in certificate management information”, “CA generation number”, “private key length”, “signature algorithm”, and “key-pair storage location” of the entry. At this time, the CA certificate issuance unit 22 does not delete information on the entry in which information on the issued CA certificate has been stored. Note that in “item number in certificate management information” in the CA management information 31, the item number of the entry in the certificate management information 32, in which information on the newly issued CA certificate is stored, is stored. It is prohibited to delete the entry in the CA management information 31. As described, by adding to the CA management information 31 information on the newly issued CA certificate, it is possible to manage each CA certificate and to keep retaining information on the CA certificate that was issued in the past. Since the CA management information 31 includes information on the storage location of the private key that corresponds to the CA certificate, an interface for accessing an old key has been retained after a new key has been generated.

When the user certificate issuance unit 23 receives a user certificate issuance request, the user certificate issuance unit 23 transmits to the key management unit 24 an instruction to sign the user certificate according to issuance request. The user certificate issuance request is given directly from the CA manager in some cases, and is given from a CA operator via a RA in other cases. In addition, examples of a user certificate issuance request form include a form for preparing a certificate CSR (PKCS#10) in a CA and a form for receiving a certificate CSR from a user. The certificate CSR is a message that is sent to a CA in order to request issuance of a public key certificate, and includes information for identifying the user and the user's public key.

First, a form (case 1) will be described in which the CA prepares an CSR, that is, a case in which a user certificate issuance request is received directly from the CA manager without passing through the RA. In this case, when the user certificate issuance unit 23 receives the user certificate issuance request, the user certificate issuance unit 23 first generates a key pair of a private key and a public key to be used by a user. Next, the user certificate issuance unit 23 generates an CSR that includes the generated public key and user identification information. Then, the user certificate issuance unit 23 instructs the key management unit 24 to issue a user certificate by using a signature algorithm that corresponds to the latest CA certificate.

In the user certificate issuance instruction to the key management unit 24, the user certificate issuance unit 23 specifically refers to the CA management information 31 and specifies the signature algorithm and the private key that correspond to the latest CA certificate. That is, the user certificate issuance unit 23 selects an entry whose “certificate type” is root CA and “item number” is the greatest in the CA management information 31, and acquires the values in the “signature algorithm” and “key-pair storage location” columns of the selected entry. Then, the user certificate issuance unit 23 causes the acquired values of “signature algorithm” and “key-pair storage location”, the public key of the user, and information for identifying the user to be included in the user certificate issuance instruction, and transmits the issuance instruction to the key management unit 24.

As described, by controlling the cryptographic technology that is used when a user certificate is issued so as to become the signature algorithm and the private key that correspond to the CA certificate that has been generated most recently, it is possible to perform a control so that a user certificate is not issued by using a private key of an old generation. Therefore, since a user certificate is not issued by using the signature algorithm or the private key of the old generation, it is possible to reduce security risks.

Thereafter, the key management unit 24, which has received the user certificate issuance instruction, gives an electronic signature to the user certificate by using the instructed signature algorithm and by using the private key that has been stored in the instructed storage location. Then, the key management unit 24 transmits the issued user certificate to the user certificate issuance unit 23.

When the user certificate issuance unit 23 receives the user certificate from the key management unit 24, the user certificate issuance unit 23 adds information on the issued user certificate to the certificate management information 32. That is, the user certificate issuance unit 23 adds a new entry to the certificate management information 32, and stores information on the newly issued user certificate in each data item of the entry. Note that at this time, the CA generation number that has been allocated to the latest CA certificate at the time point when a user certificate has been issued is stored in “CA generation number” in the certificate management information 32.

Then, the user certificate issuance unit 23 brings together the issued user certificate and the private key pair that corresponds to the user certificate in a PKSC#12 format file, and therefore, the CA manager may save the file.

Next, a form (case 2) will be described in which the CA manager receives a user certificate CSR (PKCS#10) directly from a user not via the RA. In this case, the user certificate issuance unit 23 receives the user certificate CSR that has been received from the CA manager. Then, the user certificate issuance unit 23 loads the CSR and acquires information for identifying the user and the public key of the user. As in the same manner in case 1, the user certificate issuance unit 23 instructs the key management unit 24 to issue the user certificate by using the signature algorithm and the private key that correspond to the latest CA certificate. The processes in the key management unit 24 and the user certificate issuance unit 23 are the same as those in case 1; however, since the private key is not generated in the CA in this pattern, the CA manager may only save the file of the user certificate. Note that the CSR (PKSC#10) may be a server certificate CSR that has been prepared by network equipment, etc.

Next, a case (case 3) in which a user certificate issuance request is received from the RA operator via the RA will be described. The process that is executed by the user certificate issuance unit 23 in a case in which the user certificate issuance request is received via the RA is the same as that in case 2 except that the transmission source of the received CSR is not the CA manager but the RA and the user certificate that has been processed and issued by the user certificate issuance unit 23 is transmitted to the RA.

Note that in the embodiment, the user certificate includes a server certificate for certifying a legitimacy of a server.

The key management unit 24 generates a new key pair (public key and private key), and retains the generated CA private key in the private key storage location. The key management unit 24 executes various processes by using the CA private key.

In the generation of the CA private key, the key management unit 24 receives from the CA certificate issuance unit 22 an instruction to generate the new key pair. The cryptographic algorithm (RSA) and the key length of the key to be generated is included in the instruction to generate the new key. Then, the key management unit 24 generates the public key and the private key of the instructed cryptographic algorithm and the key length, and stores the generated keys in the specified storage location. The key management unit transmits to the CA certificate issuance unit 22 information that includes information that indicates that the key pair has been generated and information that indicates the storage location of the generated public key and private key. Note that the key-pair storage location may be specified by the CA certificate issuance unit 22, and the key management unit 24 may store the generated key pair in the specified storage location.

The key management unit 24 issues by using the key pair a CA certificate, a user certificate, and a revocation list. With respect to issuance of a CA certificate, specifically, the key management unit 24 receives from the CA certificate issuance unit 22 an instruction to issue a CA certificate. The issuance instruction includes a key-pair storage location, information that indicates a cryptographic algorithm, information for identifying the CA, and the CA public key. When receiving the issuance instruction, the key management unit 24 gives an electronic signature to the public key of the CA and information for identifying the CA by using the instructed signature algorithm and by using the private key that has been stored in the instructed storage location, and issues the CA certificate.

In issuance of a user certificate, the key management unit 24 receives from the user certificate issuance unit 23 an instruction to issue the user certificate. The issuance instruction includes a CA key-pair storage location, information that indicates the signature algorithm, information for identifying the user, and the public key of the user. When receiving the issuance instruction, the key management unit 24 gives an electronic signature to the public key of the user and information for identifying the user by using the instructed signature algorithm and by using the private key that has been stored in the instructed storage location, and issues the user certificate. Note that with respect to the user certificate issuance instruction, the CA private key that is specified as a key that is used for issuing a certificate is the private key that corresponds to the latest CA certificate.

In issuance of a revocation list, the key management unit 24 receives from the revocation list issuance unit 25 a revocation list issuance instruction. The issuance instruction includes information that is listed on the revocation list, information that indicates the signature algorithm that is used for generating the electronic signature that is given to the revocation list, and information that indicates the key-pair storage location. Here, the information that is listed on the revocation list includes an invalid certificate list and various information that has been specified by the CA manager. When receiving an instruction to issue the revocation list, the key management unit 24 generates an electronic signature by using the instructed signature algorithm and by using the CA private key that has been stored in the instructed storage location, and gives the electronic signature to the revocation list. The key management unit 24 transmits the revocation list to the revocation list issuance unit 25.

The revocation list issuance unit 25 performs a control to issue a revocation list that corresponds to each generation by using the signature algorithm and the CA private key that correspond to the CA certificate of each generation. That is, each revocation list corresponds to each generation of the CA certificate, and the electronic signature of the CA that the revocation list has is generated by using the signature algorithm and the CA private key that correspond to the CA certificate of the generation which the revocation list corresponds to. For example, the electronic signature of the CA that the revocation list that corresponds to generation A has is generated by using the signature algorithm and the CA private key that correspond to the CA certificate of generation A. Note that even though there might be a plurality of private keys that correspond to CA certificates of one generation, in that case, it is assumed that the latest private key is used among the private keys that correspond to the CA certificates of each generation. Note that all the key lengths of the private keys that correspond to the CA certificates of one generation are the same.

Here, the verification application that verifies a certificate is not able to judge the validity of the electronic signature that is given to the revocation list unless the verification application supports the key length of the private key and the signature algorithm that have been used for generating the electronic signature when judging the validity of the electronic signature. In the embodiment, control is performed so that each generation of the CA certificate is incremented every time the key length of the private key or the signature algorithm is updated. Therefore, by issuing simultaneously revocation lists that correspond to respective generations, it is possible to control issuance of a revocation list according to a step that may be verified by the verification application. As a result, it is possible to continue using the certificate of the old generation that has been issued so far by using the verification application of the old generation.

In the issuance of a revocation list, the revocation list issuance unit 25 performs a control for bringing together invalid certificate lists that are to be listed on a revocation list that corresponds to each generation. That is, the revocation list issuance unit 25 performs a control so that the invalid certificate list that is listed on the revocation list that corresponds to each generation becomes a list of the invalid certificates among the certificates of the generation that is the same as that of the revocation list and of the generation that is before the generation of the revocation list. As described, by bringing together revocation information on certificates of the generation that is the same as or before the generation of the revocation list and by listing the information on the revocation list, it is possible to reduce the number of revocation lists that the certificate verification application refers to when verifying the validity of a certificate.

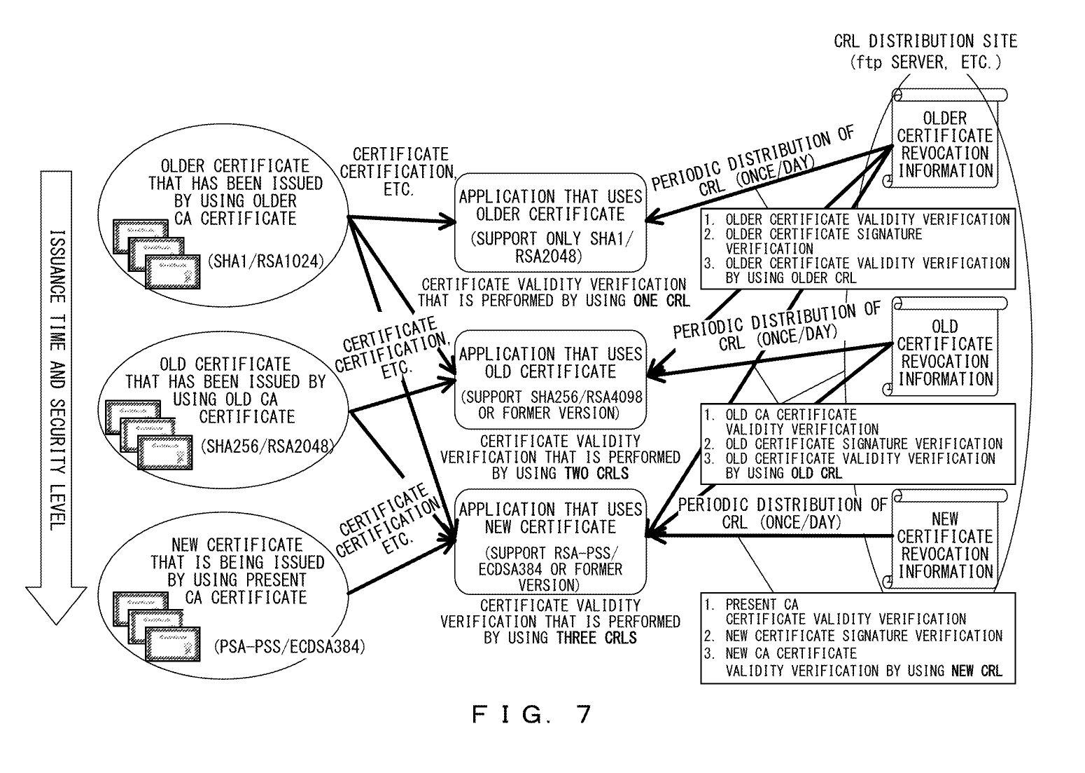

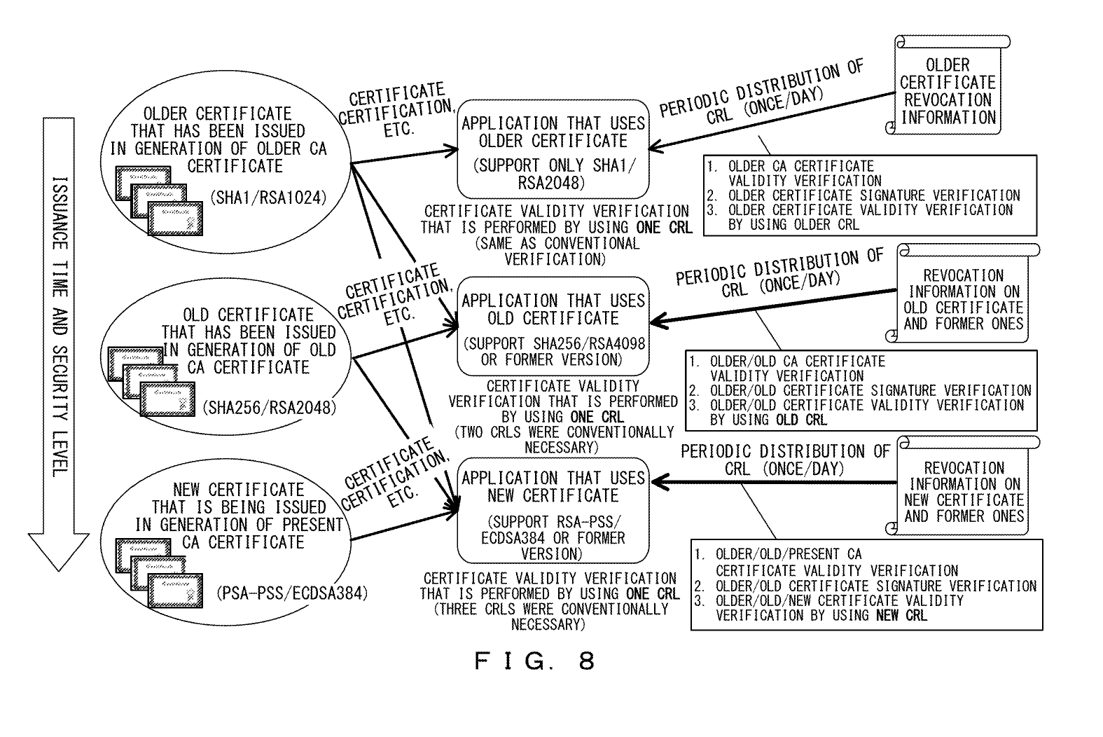

Here, validity of the embodiment will be described by comparing the case of bringing together invalid certificate lists that are listed on a revocation list and the case of listing invalid certificate lists for respective generations on the revocation lists without bringing together the invalid certificate lists. There are two forms, a Push type and Pull type, for the verification application that verifies the validity of a certificate to refer to the revocation list. First, with reference to FIGS. 7 and 8, a comparison will be made between the case of bringing together invalid certificate lists that are listed on the revocation list and the case of not bringing the invalid certificate lists together in Push type.

FIG. 7 is a diagram illustrating a state when a Push type verification application that verifies the validity of a certificate that corresponds to each generation refers to revocation lists in a case in which invalid certificate lists that are described on the revocation lists are not brought together. In the case of Push type, the verification application receives a revocation list that is periodically distributed from a revocation list distribution site. In this case, an application that uses a new certificate receives three revocation lists on which revocation information on older certificates, revocation information on old certificates, and revocation information on new certificates are listed, respectively, and verifies a certificate of each generation.

FIG. 8 is a diagram illustrating a state when the Push type verification application that verifies the validity of a certificate that corresponds to each generation refers to a revocation list in a case in which invalid certificate lists that are described on the revocation list are brought together. In this case, the application that uses a new certificate receives only one revocation list in which revocation information on or before the new certificate is brought together, and verifies the certificate of each generation. This is because, since the revocation information on or before the new certificate includes the revocation information for the older certificate and the old certificate, it is possible to verify the older certificate and the old certificate by referring to the revocation information on or before the new certificate. Therefore, by bringing together revocation information in the same manner as in the embodiment, it is possible to reduce the load of the verification application and communication traffic in verification.

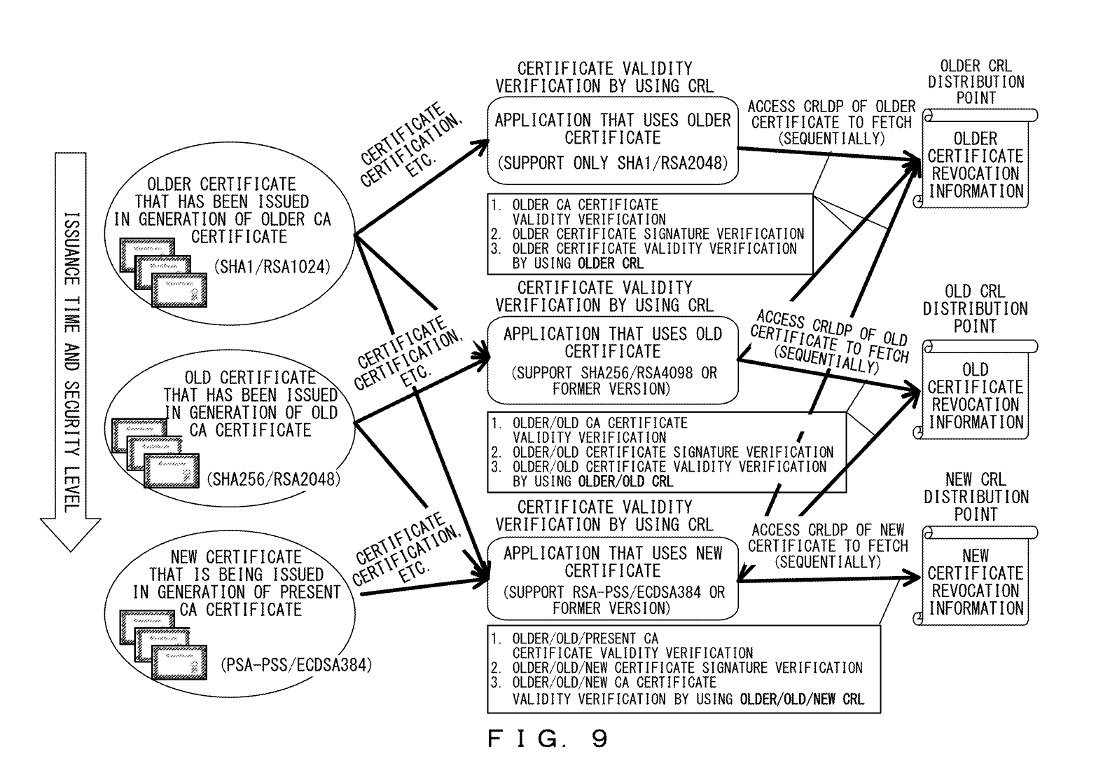

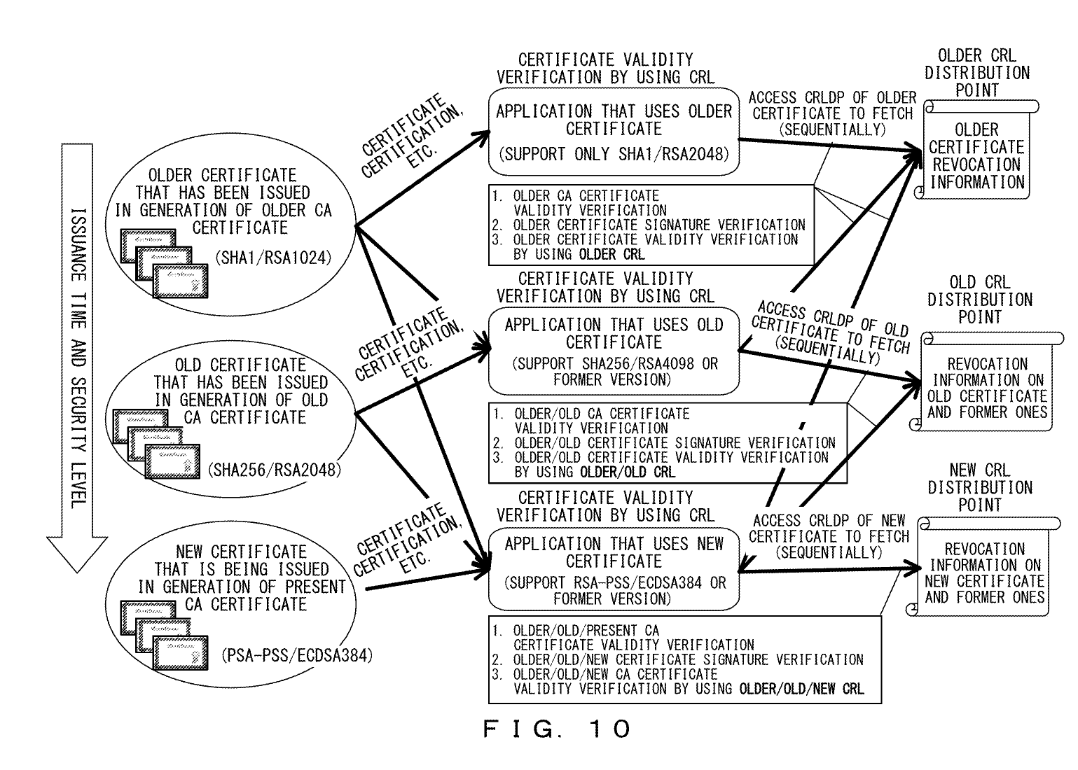

Next, with reference to FIGS. 9 and 10, a comparison will be made between the case of bringing together invalid certificate lists that are listed on the revocation list and not bringing invalid certificate lists together in a Pull type.

FIG. 9 is a diagram illustrating a state when a Pull type verification application that verifies the validity of a certificate that corresponds to each generation refers to revocation lists in a case in which invalid certificate lists that are listed on the revocation lists are not brought together. In the case of Pull type, the verification application sequentially fetches a revocation list from a revocation list distribution site that is listed on a CRL distribution point of the certificate that is a verification target. In this case, the application that uses a new certificate fetches a revocation list that corresponds to one of the older certificate, the old certificate and the new certificate, and verifies the certificate of each generation.

FIG. 10 is a diagram illustrating a state when the Pull type verification application that verifies the validity of a certificate that corresponds to each generation refers to a revocation list in a case in which invalid certificate lists that are listed on the revocation lists are brought together. In this case, in the same manner as in FIG. 9, the verification application that uses a new certificate sequentially fetches a revocation list from a revocation list distribution site that is listed on a CRL distribution point of the certificate that is a verification target, and verifies the certificate of each generation. This is because, since the revocation list acquisition destination depends on the CRL distribution point that is listed on the certificate, the number of revocation lists that are used for verification is the same as that in FIG. 9. In this case, the revocation list of each generation is released on the revocation list distribution site of each generation until operation of the application that uses an older or old certificate has been terminated. Note that when the operation of the application that uses an older or old certificate has been terminated, the revocation list of a newer generation may replace the revocation list of the older or old generation on the distribution site thereof.

As described above, by bringing together invalid certificate lists that are listed on revocation lists, it is possible to reduce a load that is imposed on validity verification.

In addition, when the revocation list issuance unit 25 receives from the CA manager an issuance stop request for the revocation list that corresponds to a specified generation, the revocation list issuance unit 25 performs a control for stopping the issuance of the revocation list of the generation that is the stop request target. Thus, for example, in a case in which the operation of the certificate verification application of the old generation has been terminated, it is possible to stop an issuance of the revocation list of the generation whose operation has been terminated.

Furthermore, the revocation list issuance unit 25 controls for each generation whether or not issuance of a revocation list is made possible. That is, the revocation list issuance unit 25 sets whether revocation list issuance is prohibited or permitted for each generation.

The revocation list issuance unit 25 controls issuance of the revocation list that corresponds to the generation of the CA that has been specified by the CA manager in a revocation list issuance request.

Next, each control that is performed by the revocation list issuance unit 25 will be described in detail.

In a control for associating the generation of a revocation list and that of a CA certificate, the revocation list issuance unit 25 refers to the CA management information 31 and specifies the signature algorithm and the CA private key of the electronic signature that is attached to the revocation list. In addition, the revocation list issuance unit 25 specifies the issuance advisability for each revocation list type (CRL, ARL, and EPRL) with respect to each CA generation number. When a CA certificate is within a valid period and is not revoked and revocation list issuance permission is true in the CA management information 31, the revocation list issuance unit 25, in the CA management information 32, narrows down certificate types for each revocation list type (in case of ARL, root CA/CA, in case of EPRL, standard, and in case of CRL, all), extracts certificates whose CA generation number is less than or equal to the “CA generation number” and which is within the valid period and which has been revoked, and then sets the extracted certificates to a target revocation list. The revocation list issuance unit 25 refers to “signature algorithm” and “key-pair storage location” of the extracted entry in the CA management information 31, and specifies the signature algorithm that is used for the electronic signature of the CA of the target revocation list and the storage location of the key pair that is used for the electronic signature. As described, by performing a control for associating the generation of the revocation list and that of the CA certificate, it is possible to avoid an inconsistency wherein the validity of the certificate that has a great signature strength is certified by a revocation list that has a small strength.

In a control for bringing together invalid certificates that are to be listed on a revocation list that corresponds to each generation, specifically, the revocation list issuance unit 25 refers to the certificate management information 32 and performs a control for bringing together invalid certificate lists. In the control, the revocation list issuance unit 25 first selects in the certificate management information 32 all the entries whose “CA generation number” is less than or equal to the CA generation number of the target revocation list. Next, the revocation list issuance unit 25 extracts from among the selected entries a certificate whose “revocation” is “true” and whose present date (process execution date) is on or after the date that is indicated by “start date” of “valid period” and on or before the date that is indicated by “expiration date”. The entries that have been extracted in this manner are the entries which indicate invalid certificates whose generation is older than or equal to the generation that corresponds to the revocation list, and these certificates are included in the target revocation list. Thus, the revocation list issuance unit 25 lists information on the extracted invalid certificates on the invalid certificate list of the revocation list. Specifically, the information includes “serial number”, “revocation date” and “revocation reason”.

In a control for stopping revocation list issuance, specifically, the revocation list issuance unit 25 first receives from the CA manager a request for stopping issuance of a revocation list that corresponds to a specified generation.

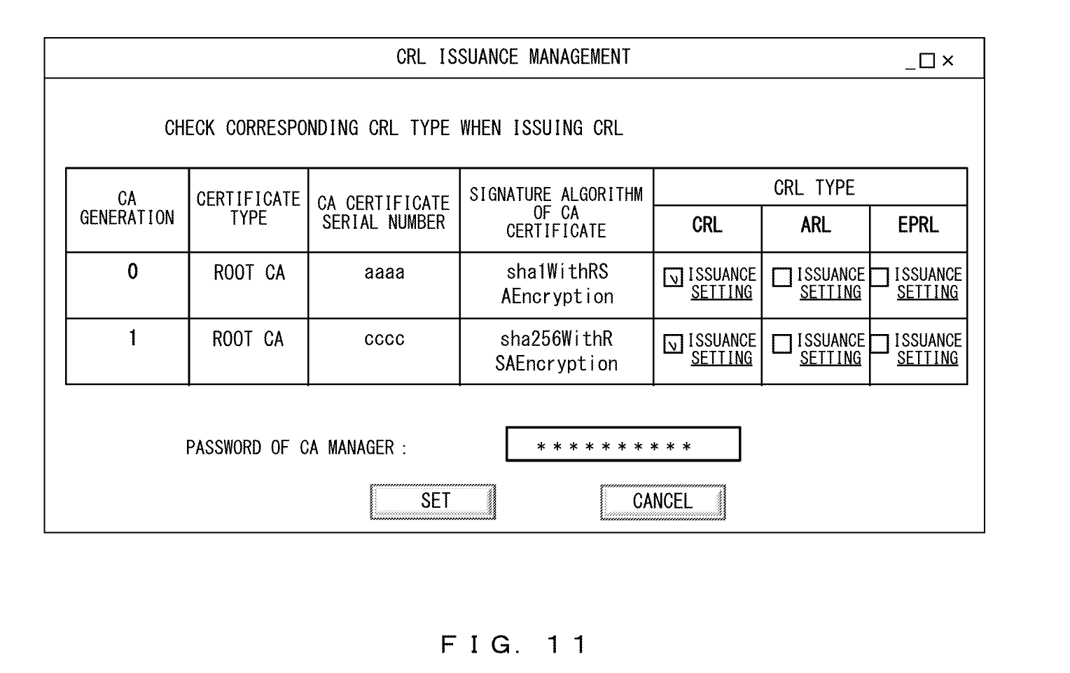

FIG. 11 illustrates an example of the screen of an application that is used when the CA manager inputs a request for stopping issuing a revocation list. In FIG. 11, it is possible to input an issuance stop instruction for each generation of the CA or for each revocation list type. That is, by unchecking the “issuance” checkbox on the “CRL type” column of the table on the screen, it is possible to input the revocation list issuance stop instruction. Note that information on the serial number and the signature algorithm of the CA certificate of each generation that is displayed on the screen in FIG. 11 is information on the serial number and the signature algorithm of the latest CA certificate among the CA certificates of each generation.

When receiving the request for stopping issuing the revocation list, the revocation list issuance unit 25 refers to the CA management information 31, extracts the entry of the CA certificates whose generation is the same as the generation that the target revocation list corresponds to, and sets “false” as the value of “revocation list issuance permission” of the extracted entry. Extraction of the entry of the CA certificate whose generation is the same as that of the target revocation list is executed by extracting the entry whose “item number” is greatest from among entries whose “CA generation number” in the CA management information 31 matches the CA generation number of the revocation list that is the stop request target.

In a control for whether or not to allow issuance of the revocation list of each generation, specifically, the revocation list issuance unit 25 judges whether or not the following three conditions are satisfied when the revocation list of each generation is issued, and prohibits the issuance of the revocation list when the conditions are satisfied.

(1) The CA certificate of the CA generation number that is the same as the CA generation number that the revocation list corresponds to has been revoked.
(2) The valid period of the CA certificate of the CA generation number that is the same as the CA generation number that the revocation list corresponds to has expired.
(3) Revocation list issuance prohibition is set by the CA manager.

More specifically, with respect to (1) and (2), the revocation list issuance unit 25 refers to the certificate management information 32 and judges whether or not the condition (1) or (2) is satisfied. With respect to (3), the revocation list issuance unit 25 refers to the CA management information 31 and judges whether or not the condition (3) is satisfied.

With respect to (1), the revocation list issuance unit 25 extracts in the certificate management information 32 the entry whose “item number” is greatest from among the entries whose “certificate type” is “root CA” or “intermediate CA” and whose “CA generation number” matches the CA generation number of the revocation list that is an issuance target. Then, the revocation list issuance unit 25 judges whether or not the value of “revocation” of the extracted entry is “true”. When the value of “revocation” of the extracted entry is “true”, the revocation issuance unit 25 judges that the revocation list that is the issuance target satisfies condition (1).

With respect to (2), the revocation list issuance unit 25 extracts in the certificate management information 32 the entry whose “item number” is greatest from among the entries whose “certificate type” is “root CA” or “intermediate CA” and whose “CA generation number” matches the CA generation number of the revocation list that is an issuance target. Then, the revocation list issuance unit 25 judges whether or not the present date (process execution date) is before the date that is indicated by “start date” of “valid period” of the extracted entry and after the date that is indicated by “expiration date” of the extracted entry. For example, in a case in which the present date is after the date that is indicated by “expiration date” of “valid period” of the extracted entry, the revocation list issuance unit 25 judges that the revocation list that is the issuance target satisfies condition (2).

With respect to (3), the revocation list issuance unit 25 extracts in the CA management information 31 the entry whose “item number” is greatest from among the entries whose “CA generation number” matches the CA generation number of the revocation list that is an issuance target. Then, the revocation list issuance unit 25 judges whether or not the value of “revocation list issuance permission” of the extracted entry is “false”. In a case in which “revocation list issuance permission” of the extracted entry is “false”, the revocation list issuance unit 25 judges that the revocation list that is the issuance target satisfies condition (3). Note that it is possible to set the revocation list issuance permission for each of “CRL”, “ARL” and “EPRL”, and when a judgment is made, it is assumed that according to which of “CRL”, “ARL” and “EPRL” the issuance target revocation list is, the value of the corresponding item is referred to.

Next, a revocation list issuance control will be described. When the revocation list issuance unit 25 receives from the CA manager a revocation list issuance request, the revocation list issuance unit 25 starts a revocation list issuance process control.

The issuance request from the CA manager includes setting information that is used for issuing a revocation list. For example, setting information includes information that indicates the generation of the CA and information on revocation list type settings. The information on the revocation list type settings is setting information that corresponds to each item in FIG. 3B.

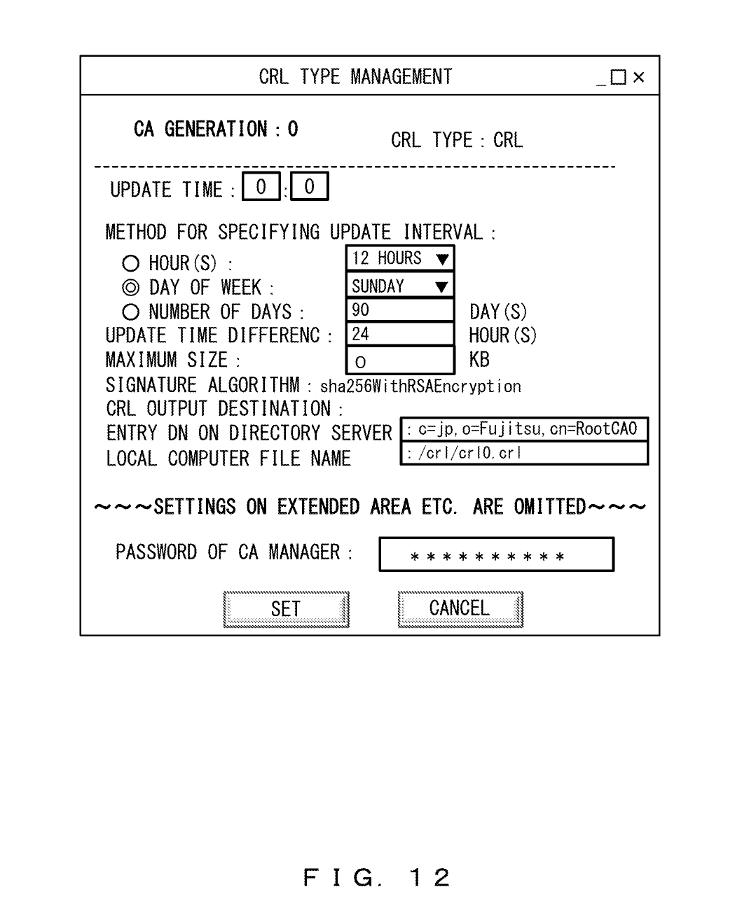

FIG. 12 illustrates an example of the application screen that is used when the CA manager inputs the revocation list type settings. In FIG. 12, it is possible to specify the update time, the update interval, the update time difference, the maximum size, the revocation list output destination directory, and the revocation list output destination file. Note that information that is displayed in the column of the signature algorithm in FIG. 12 is information on the signature algorithm of the CA certificate whose CA generation number is the same as that of the revocation list.

When receiving a revocation list type setting input from the CA manager, the revocation list issuance unit 25 performs a revocation list output destination overlap avoidance control. That is, the revocation list issuance unit 25 performs a control so that the output destination of the target revocation list that has been specified by the CA manager does not overlap the output destination of the revocation list of another generation. That is, the revocation list issuance unit 25 refers to the CA management information 31, and specifies output destinations of all the revocation lists whose generations are different from that of the target revocation list. Then, the revocation list issuance unit 25 judges whether or not the output destination of the target revocation list that has been specified by the CA manager is different from the output destinations of all the revocation lists whose generations are different from that of the target revocation list.

In a casein which the revocation list issuance unit 25 judges that the output destination that has been specified by the CA manager is the same as the output destination of a revocation list whose generation is different from that of the target revocation list, the revocation list issuance unit 25 executes an error process. In the error process, for example, the revocation list issuance unit 25 executes a process for displaying to the CA manager a message to the effect that the specified output destination overlaps the output destination of the revocation list of another generation.

In contrast, in a case in which the revocation list issuance unit 25 judges that the output destination that has been specified by the CA manager is different from the output destinations of all the revocation lists whose generations are different from that of the target revocation list, the revocation list issuance unit 25 receives the input of the revocation list type settings that are input from the CA manager. Then, the revocation list issuance unit 25 extracts in the CA management information 31 the entry whose “item number” is greatest from among the entries whose “CA generation number” matches the CA generation number of the target revocation list. Then, the revocation list issuance unit 25 stores information on the output destination that has been specified by the CA manager in “revocation list output destination directory” and “revocation list output destination file” of the extracted entry.

As described, by making unique the output destination of the revocation list for each CA generation, the following effect may be obtained. That is, since the revocation list distribution location may be changed at a timing such as a verification application renewal timing when a cryptographic technology that may be used has changed, the existing verification application is not affected. In addition, since the output destination of the revocation list of the old generation is maintained even though the CA generation number was changed when the CA certificate was issued, the verification application is not affected.

In the issuance control, the revocation list issuance unit 25 performs a control for associating the revocation list and the generation of the CA certificate, and specifies the signature algorithm that is used for the electronic signature of the CA of the target revocation list and the storage location of the key pair that is used for the electronic signature.

Next, the revocation list issuance unit 25 performs a control for bringing together invalid certificates that are to be included on a revocation list that corresponds to each generation, and specifies the invalid certificate list that is to be included in the revocation list.

Then, the revocation list issuance unit 25 transmits to the key management unit 24 a revocation list issuance instruction (signing instruction) together with information that is to be listed on the revocation list, information that indicates the signature algorithm that is used for revocation list issuance, and information that indicates the storage location of the key pair that is used for the electronic signature. Here, information that is to be listed on the revocation list includes the invalid certificate list, and various information that has been specified by the CA manager.

Thereafter, the key management unit 24, which has received the revocation list issuance instruction, executes a revocation list issuance process. Then, the revocation list issuance unit 25 receives from the key management unit 24 the issued revocation list.

When receiving the issued revocation list, the revocation list issuance unit 25 stores in the revocation list management information 33 information on the issued revocation list in association with the CA generation number of the revocation list. That is, the revocation list issuance unit 25 adds a new entry to the revocation list management information 33, stores corresponding information on the issued revocation list in each item of the entry, and stores the CA generation number of the revocation list in “CA generation number”. Note that as described above, the CA generation number of the revocation list corresponds to the CA generation number of the CA certificate.

As described above, the revocation list issuance unit 25 executes a revocation list issuance control process. Note that the revocation list issuance unit 25 has a function for receiving a revocation list search request from the CA manager and provides a search result for the search request to the CA manager.

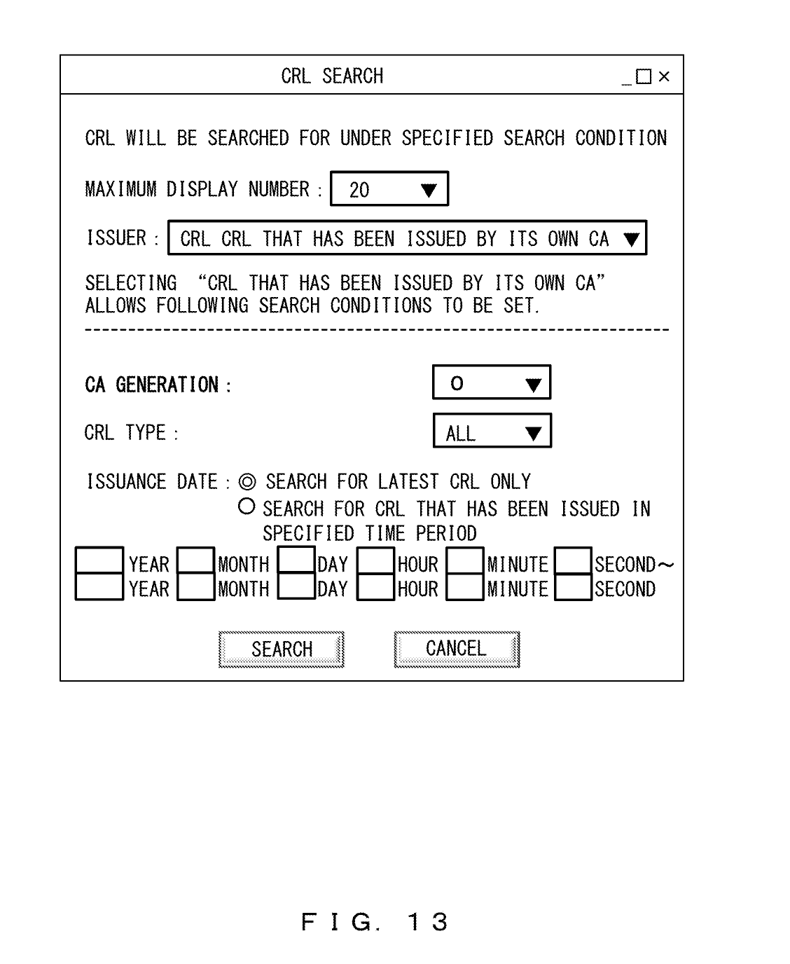

FIG. 13 illustrates an example of an application screen that is used when the CA manager inputs a revocation list search request. In FIG. 13, it is possible to input a revocation list search request by specifying the generation of the CA, the revocation list type, and the issuance date.

When receiving the revocation list search request, the revocation list issuance unit 25 searches for a revocation list that satisfies the requested conditions, and outputs a result via a specified output device. Specifically, in a case in which the generation of the CA has been specified in the revocation list search request, the revocation list issuance unit 25 first extracts in the revocation list management information 33 the entry whose “CA generation number” corresponds to the specified generation number of the CA. Then, the revocation list issuance unit 25 outputs information on the revocation list of the extracted entry.

The certificate revocation unit 26 executes a revocation process for the CA certificate and the user certificate. When receiving a revocation application for a certificate, the certificate revocation unit 26 executes the revocation process for the certificate by updating the certificate management information 32. Note that the revocation application includes a case in which the RA operator uses the manager terminal 11 and applies for revocation of the user certificate via the RA operation apparatus 12, and a case in which the CA manager applies for revocation of the CA certificate to the CA operation apparatus 10 by using the manager terminal 11. Here, for convenience of explanation, a certificate that is a revocation request target is referred to as a target certificate.

When the target certificate is a CA certificate, the certificate revocation unit 26 executes the revocation process for all the CA certificates that correspond to the generation of the target certificate or the generation before that. Thus, in a case in which the CA certificate of the new generation is revoked, the CA certificate whose CA generation number is older than that is simultaneously revoked. In addition, for example, it is possible to prevent an inconsistency wherein even though it is not possible to perform verification that uses the revocation list of the latest CA generation number, it is possible to perform verification that uses the revocation list of the CA generation number that is older than the latest CA generation number.

Specifically, the certificate revocation unit 26 first refers to the certificate management information 32, and specifies all the CA certificates that correspond to the CA generation number that is the same as or before the CA generation number of the target certificate. For example, the certificate revocation unit 26 specifies the CA certificates by extracting in the certificate management information 32 entries whose values of “CA generation number” are smaller than or equal to the CA generation number of the target certificate and whose “certificate type” is “root CA” or “intermediate CA”. Then, the certificate revocation unit 26 executes the revocation process for all the specified CA certificates.

Specifically, for example, the revocation process is for setting “true” to “revocation”, sets the date when the revocation process was executed to “revocation date”, and sets a revocation reason to “revocation reason” in the certificate management information 32.

In a case in which the target certificate is the user certificate, the certificate revocation unit 26 executes the revocation process on the target certificate.

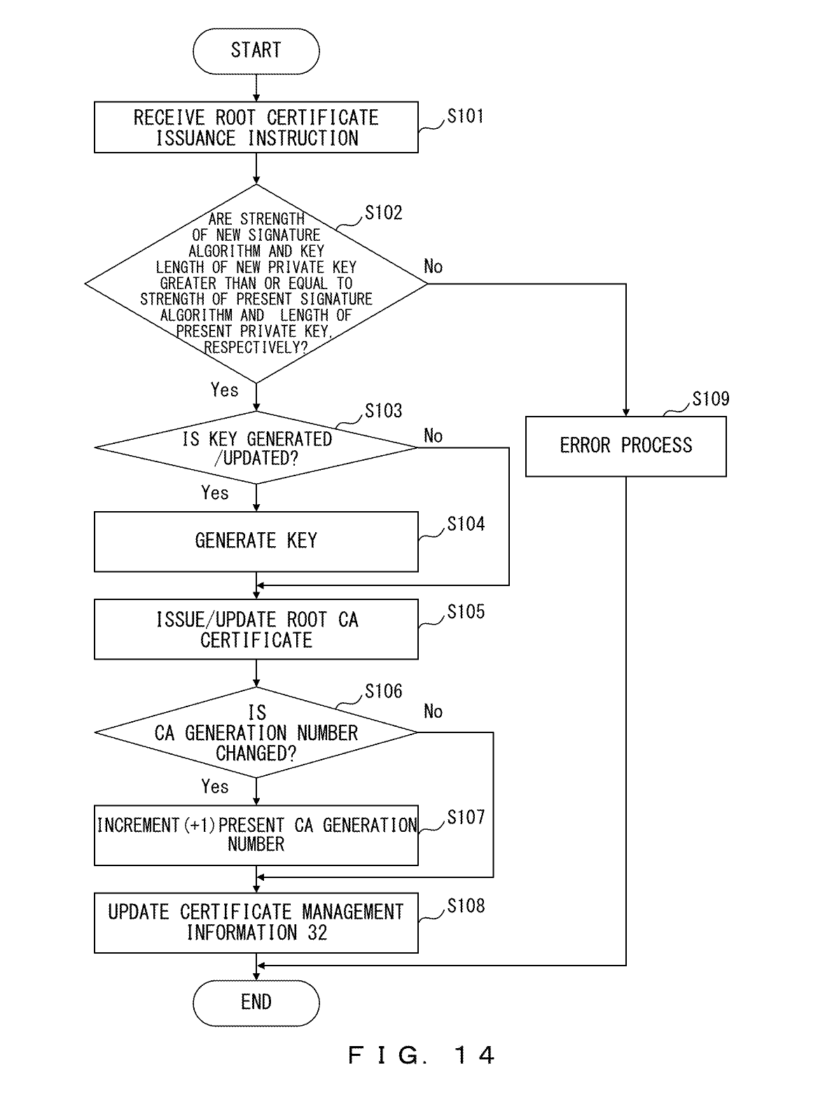

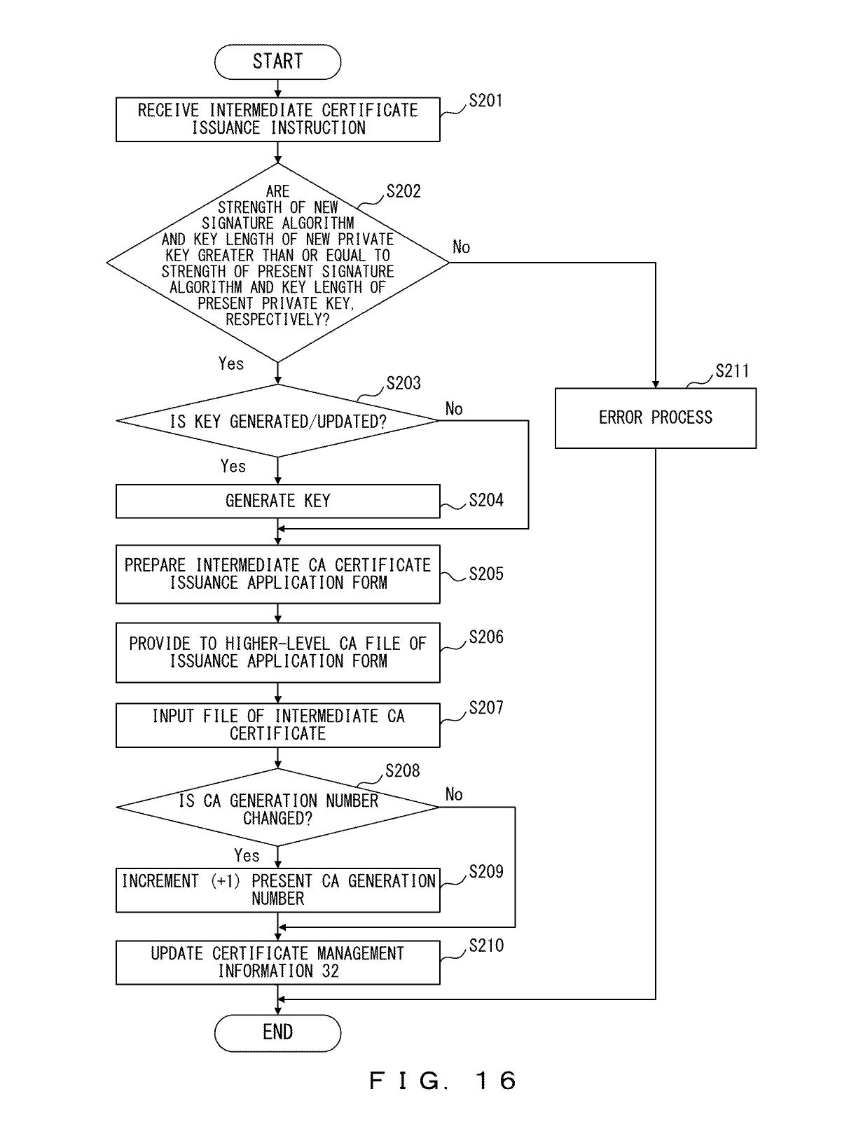

Next, an operation flow for issuing a CA certificate will be described with reference to FIGS. 14 and 16. FIG. 14 is an example of a flowchart illustrating details of a CA certificate issuance process in the root CA.

In FIG. 14, the CA certificate issuance unit 22 first receives from the CA manager a new CA certificate issuance instruction (S101). The CA certificate issuance instruction includes information that indicates whether or not to newly generate a key pair, and information on the signature algorithm of the CA certificate to be newly issued. In a case in which the issuance instruction includes information that indicates an instruction to generate a new key pair, the instruction includes information on the key length of the new key pair. Here, in FIG. 14, for convenience of explanation, a CA certificate to be newly issued is referred to as a new CA certificate.

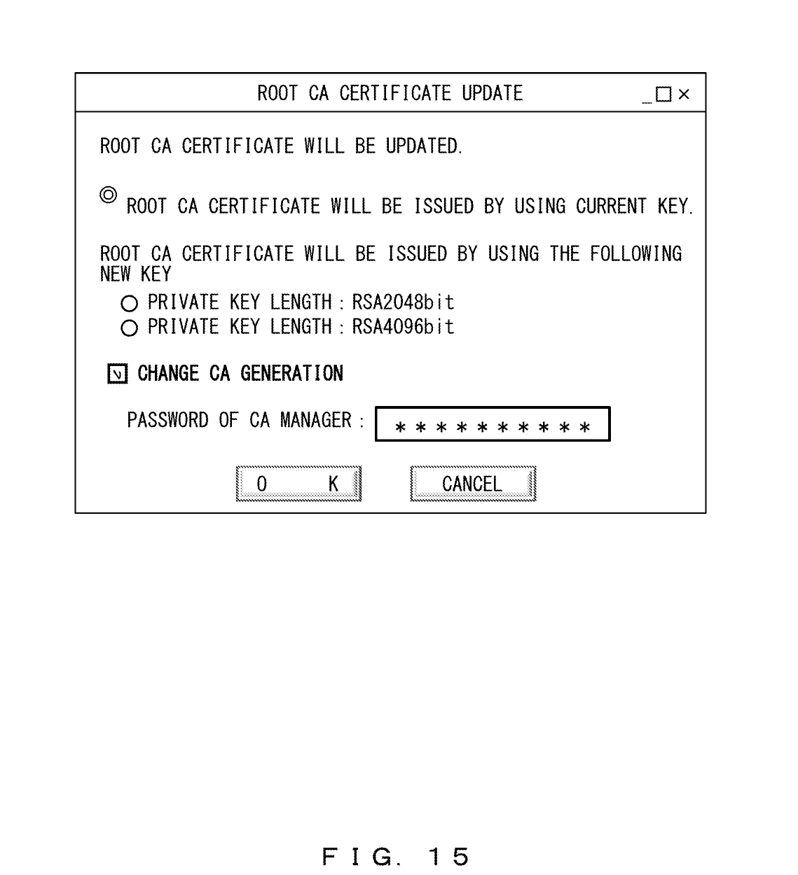

FIG. 15 illustrates an example of the application screen that is used when the CA manager inputs a CA certificate issuance instruction in the root CA. In the example in FIG. 15, with respect to the CA private key that is used for issuing the root CA certificate, a selection is available between the present private key and a private key to be newly generated. In addition, in the case of newly generating a private key, it is possible to specify the key length of the private key and the public key algorithm (such as RSA). Furthermore, it is possible to set whether or not to change the generation of the root CA.

Next, the CA certificate issuance unit 22 judges whether or not the strength of the signature algorithm that corresponds to the new CA certificate and the key length of the private key that corresponds to the new CA certificate are greater than or equal to the strength of the signature algorithm that corresponds to the present CA certificate that has been generated most recently and the key length of the private key that corresponds to the present CA certificate (S102). Specifically, the CA certificate issuance unit 22 first refers to the “signature algorithm” column of the record whose value of “item number” is greatest in the CA management information 31 and recognizes the signature algorithm of the present CA certificate. Next, the CA certificate issuance unit 22 confirms with reference to the strength information 34 the strength of the recognized signature algorithm and the strength of the signature algorithm of the new CA certificate that has been specified by means of the issuance instruction. Then, the CA certificate issuance unit 22 judges whether or not the strength of the signature algorithm of the new CA certificate that has been specified by means of the issuance instruction is greater than or equal to the strength of the signature algorithm of the present CA certificate. In addition, the CA certificate issuance unit 22 refers to the “private key length” column of the record whose value of “item number” is greatest in the CA management information 31, and recognizes the key length of the private key that corresponds to the present CA certificate. The CA certificate issuance unit 22 judges whether or not the key length of the private key that has been specified by means of the issuance instruction is greater than or equal to the key length of the private key that corresponds to the present CA certificate.

In a case in which it has been judged that the strength of the specified signature algorithm is less than the strength of the signature algorithm of the present CA certificate or it has been judged that the key length of the specified private key is less than the key length of the private key that corresponds to the present CA certificate (No in S102), the CA certificate issuance unit 22 executes the error process (S109). In the error process, for example, the CA certificate issuance unit 22 may display a warning indicating that the strength of the CA certificate cannot be lowered. After the error process, the process transitions to “end”. As described, since the process is terminated after the error process, the strength of the new CA certificate is prevented from being lower than that of the old CA certificate.

In contrast, in a case in which the CA certificate issuance unit 22 judges that the strength of the specified signature algorithm and the key length of the specified private key are greater than or equal to the strength of the signature algorithm that corresponds to the present CA certificate and the key length of the private key that corresponds to the present CA certificate (Yes in S102), the CA certificate issuance unit 22 judges whether or not to generate a new CA private key (S103). Specifically, the CA certificate issuance unit 22 judges whether or not to generate a new CA private key according to information that indicates whether or not to issue the new key pair that is included in the new issuance instruction that has been received in S101. In a case in which it has been judged that the new CA private key will not be generated (No in S103), the process transitions to S105.

In contrast, when the CA certificate issuance unit 22 judges that the new CA private key will be generated (Yes in S103), the CA certificate issuance unit 22 instructs the key management unit 24 to generate the new CA private key (S104). The key generating instruction includes information for specifying the key length of the new key pair to be generated and information for specifying the public key algorithm (RSA, etc.) of the key to be generated. The key management unit 24, which has received the key generating instruction, generates the new key pair in an unused token in the key management unit by using the public key algorithm and the key length that are included in the key generating instruction. Then, the key management unit 24 transmits to the CA certificate issuance unit 22 information that indicates that the key has been generated and information that indicates the storage location (token number) of the generated key. The CA certificate issuance unit 22 receives the transmitted information.

Next, the CA certificate issuance unit 22 executes the CA certificate issuance control (S105). That is, the CA certificate issuance unit 22 specifies the storage location of the key that has been received from the key management unit 24 as a key generation result and acquires the public key from the key management unit 24. Then, the CA certificate issuance unit 22 generates the CA certificates that include the public key, and instructs the key management unit 24 to sign the new CA certificate. In the instruction to sign the CA certificate, the CA certificate issuance unit 22 gives an instruction to issue the CA certificate by using the key pair of the CA certificate that has been generated most recently. That is, in a case in which the CA certificate issuance unit 22 receives from the CA manager an instruction to generate a new key pair, the CA certificate issuance unit 22 instructs the key management unit 24 to sign the CA certificate that includes the newly generated CA public key by using for the electronic signature the CA private key that has been newly generated in S104. In a case in which there are no instructions to generate the new key pair, the CA certificate issuance unit 22 refers to the CA management information 31, and instructs the key management unit 24 to sign the CA certificate by using for the electronic signature the CA private key that corresponds to the latest CA certificate that has been issued most recently. The key management unit 24 signs the new CA certificate and transmits the CA certificate to the CA certificate issuance unit 22. The CA certificate issuance unit 22 receives the CA certificate that has been returned from the key management unit 24.

Next, the CA certificate issuance unit 22 judges whether or not to change the CA generation number that has been allocated to the newly issued CA certificate from the CA generation number that has been allocated to another CA certificate most recently (S106). The CA generation number is incremented in a case in which the signature algorithm that corresponds to the CA certificate that has been newly issued in S105 is changed from the signature algorithm that corresponds to the CA certificate that has been issued before (before the certificate that has been issued in S105). Alternatively, the CA generation number is also incremented in a case in which the key length of the private key that corresponds to the CA certificate that has been newly issued in S105 is changed from the key length of the private key that corresponds to the CA certificate that has been issued before (before the certificate that has been issued in S105). Note that whether or not to change the CA generation number in a case in which the CA manager manages the key length and the signature algorithm of each generation may be instructed from the CA manager.

In S106, specifically, for example, the CA certificate issuance unit 22 judges whether or not the signature algorithm of the CA certificate that has been issued in S105 does not match “signature algorithm” of all the records in the CA management information 31. In a case in which the CA certificate issuance unit 22 judges that the signature algorithm does not match “signature algorithm” of all the records in the CA management information 31, the CA certificate issuance unit 22 decides to change the CA generation number. In addition, the CA certificate issuance unit 22 judges whether or not the key length of the private key that corresponds to the CA certificate that has been issued in S105 is greater than “private key length” of the record whose value of “item number” is the greatest in the CA management information 31. In a case in which the CA certificate issuance unit 22 judges that the key length of the private key that corresponds to the CA certificate that has been issued in S105 is greater than “private key length” of the record whose value of “item number” is the greatest in the CA management information 31, the CA certificate issuance unit 22 decides to change the CA generation number.

In contrast, in a case in which the following two conditions are satisfied, the CA certificate issuance unit 22 decides not to change the CA generation number. One of the two conditions is that the signature algorithm of the CA certificate that has been issued in S105 matches “signature algorithm” of one of the records in the CA management information 31. The other of the two conditions is that the key length of the private key that corresponds to the CA certificate that has been issued in S105 is less than or equal to the value of “private key length” of the record whose value of “item number” is greatest in the CA management information 31. Note that in S106, the CA certificate issuance unit 22 may decide whether or not to change the CA generation number according to an instruction from the CA manager.

In S106, in a case in which it has been decided not to change the CA generation number (No in S106), the process transitions to S108. In contrast, in a case in which it has been decided to change the CA generation number (Yes in S106), the CA certificate issuance unit 22 increments (+1) the CA generation number (S107). Specifically, for example, the CA certificate issuance unit 22 sets as the new CA generation number the value that is obtained by incrementing the value of “CA generation number” of the entry whose “item number” is greatest in the CA management information 31.

Next, the CA certificate issuance unit 22 updates the certificate management information 32 (S108). That is, the CA certificate issuance unit 22 associates the CA certificate that has been newly issued in S105 with the CA generation number, and records them in the certificate management information 32. At the same time, the CA certificate issuance unit 22 records in the CA management information 31 information that is obtained by associating the CA certificate that has been newly issued in S105 with the CA generation number that has been allocated to the CA certificate.

FIG. 16 is an example of a flowchart illustrating details of the CA certificate issuance process in the intermediate CA. In FIG. 16, steps S201-S204 and S211 are the same as steps S101-S104 and S109 in FIG. 14, respectively.

In S205 in FIG. 16, the CA certificate issuance unit 22 prepares an intermediate CA certificate CSR (S205). The CSR includes the CA public key of the intermediate CA. In a case in which a new key pair has been generated in S204, the CA public key that is included in the CSR is the public key that corresponds to the private key that has been generated in S204. In a case in which a new key pair has not been generated in S204, the CA public key that is included in the CSR is the public key that corresponds to the CA certificate that has been generated most recently. That is, the public key is the public key that corresponds to the private key of the CA certificate of the entry whose “item number” is greatest in the CA management information 31.

Next, the CA certificate issuance unit 22 prepares a certificate CSR for requesting issuance of the certificate to the higher-level CA and outputs it as a file (S206). When the file of the certificate CSR from the intermediate CA is input to the higher-level CA, the higher-level CA issues an intermediate CA certificate and outputs the intermediate CA certificate as a file.

Then, the CA certificate issuance unit 22 receives from the higher-level CA operation apparatus 10 the intermediate CA certificate file and inputs the file (S207).

Steps S208-S210 are the same as steps S106-S108 in FIG. 14, respectively.

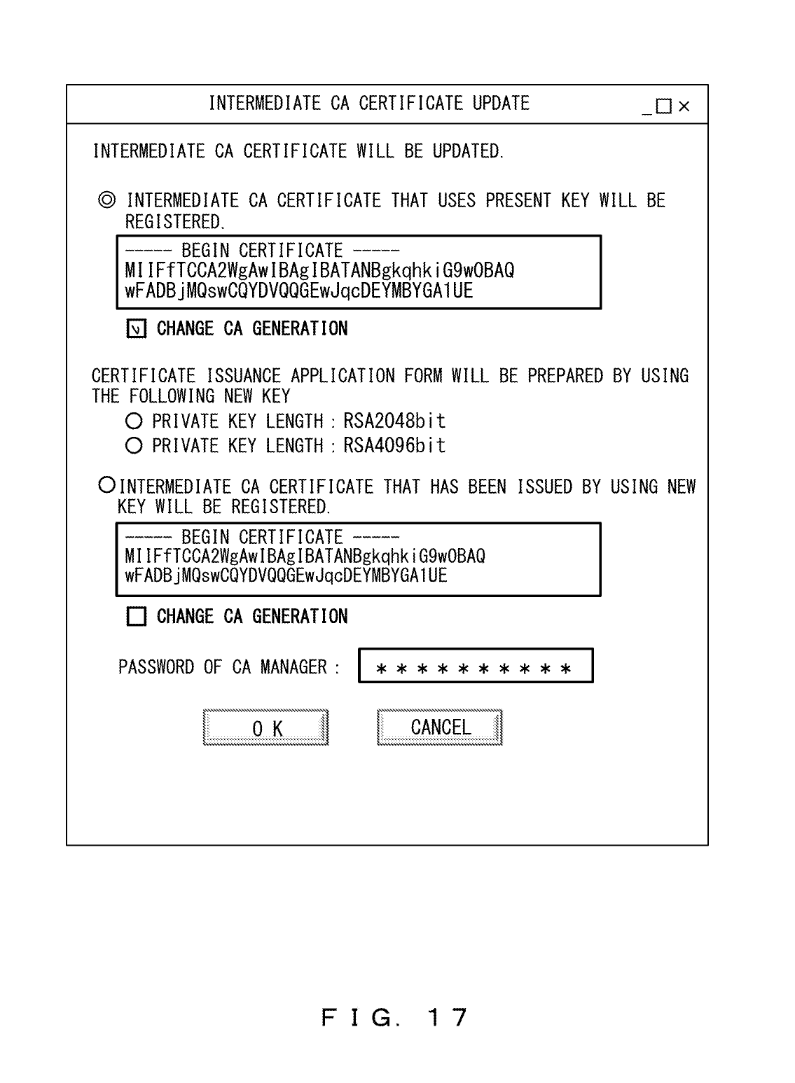

FIG. 17 illustrates an example of the application screen that is used when the CA manager inputs a CA certificate issuance instruction or registers an intermediate CA certificate in the intermediate CA. The example in FIG. 17 illustrates selecting the registration instruction of the intermediate CA certificate that uses the present key and “changing the generation of the CA”. Note that in the case of issuing an intermediate CA certificate that uses a new key pair, the registration of the intermediate CA certificate has been completed by first selecting a key length of the private key at “A certificate CSR will be prepared by using the following new key.”, outputting the CSR as a file, causing the higher-level CA to issue the certificate, receiving the certificate file, and finally inputting the certificate file at “The intermediate CA certificate that has been issued by using the new key will be registered.”

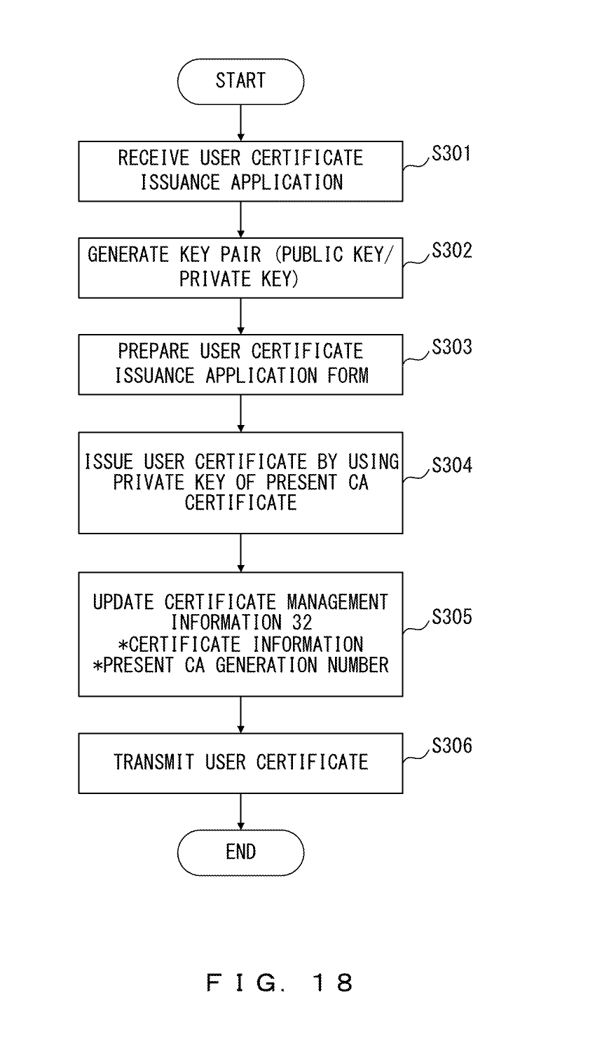

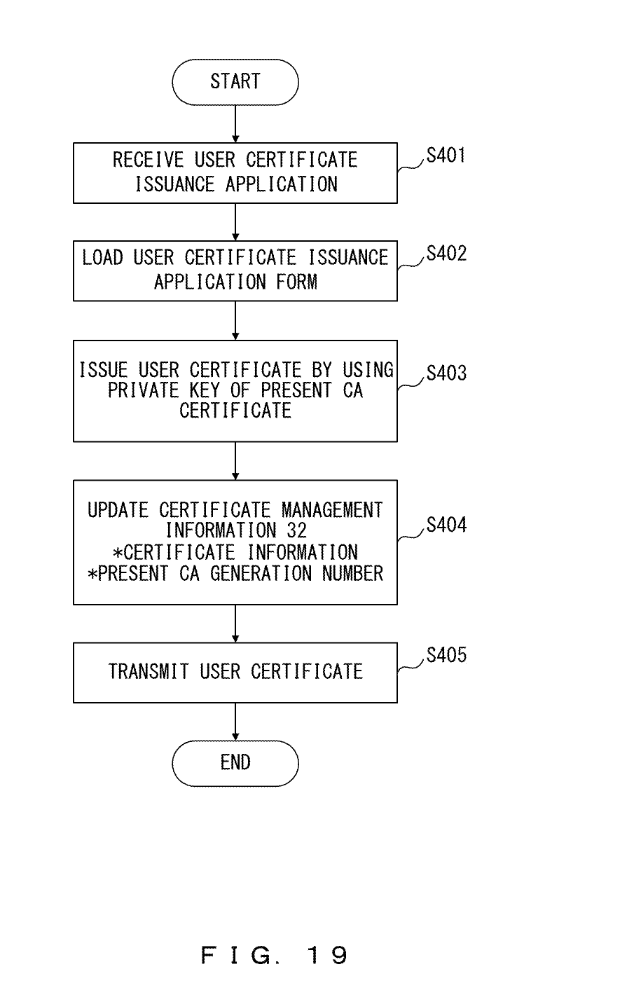

Next, the operation flow of the user certificate issuance process will be described with reference to FIGS. 18 and 19 according to a form in which the user certificate has been issued. The operation flow in the form (case 1) in which an CSR is prepared in the CA in the case of receiving the user certificate issuance request not via the RA will be described with reference to FIG. 18. Details of the user certificate issuance process in the form (case 2) in which an CSR is prepared by a user in the case of receiving the user certificate issuance request not via the RA will be described with reference to FIG. 19. In addition, details of the user certificate issuance process in the CA in the case (case 3) of receiving the user certificate issuance request via the RA will be described with reference to FIG. 19.

FIG. 18 is an example of the flowchart illustrating details of the user certificate issuance process in case 1.

In FIG. 18, first, the user certificate issuance unit 23 receives from the CA manager a user certificate issuance request (S301). Then, the user certificate issuance unit 23 requests that the key management unit 24 generate the key pair of the private key and the public key to be used for the user certificate (S302).

Then, the user certificate issuance unit 23 prepares the CSR that includes the public key that has been generated in S302 and user identification information (S303).

Then, the user certificate issuance unit 23 issues the user certificate by using the signature algorithm and the private key that correspond to the latest CA certificate (S304).

Then, the user certificate issuance unit 23 adds to the certificate management information 32 information on the user certificate that has been issued in S304 (S305). That is, the user certificate issuance unit 23 associates information on the user certificate that has been issued in S304 with the CA generation number of the latest CA certificate and records them in the certificate management information 32.

Then, the user certificate issuance unit 23 sends the user certificate that has been issued in S304 to the CA manager (S306).

FIG. 19 is an example of the flowchart illustrating details of the user certificate issuance process in case 2 and case 3. The difference in process from case 1 that has been described with reference to FIG. 18 is that the user or the RA prepares the user certificate CSR and the user certificate issuance unit 23 receives the CSR from the user or the RA. The processes other than that are the same as those in case 1.

In FIG. 19, the user certificate issuance unit 23 first receives a user certificate issuance application (S401). The issuance application that has been received here includes the user certificate CSR.

Then, the user certificate issuance unit 23 loads the CSR (S402).

Steps S403-S405 are the same as steps S304-S306 in FIG. 18. Note that the process in which the root CA issues the CA certificate of the intermediate CA for the intermediate CA is the same process as described in FIG. 19. In that case, the user certificate in FIG. 19 corresponds to the CA certificate of the intermediate CA.

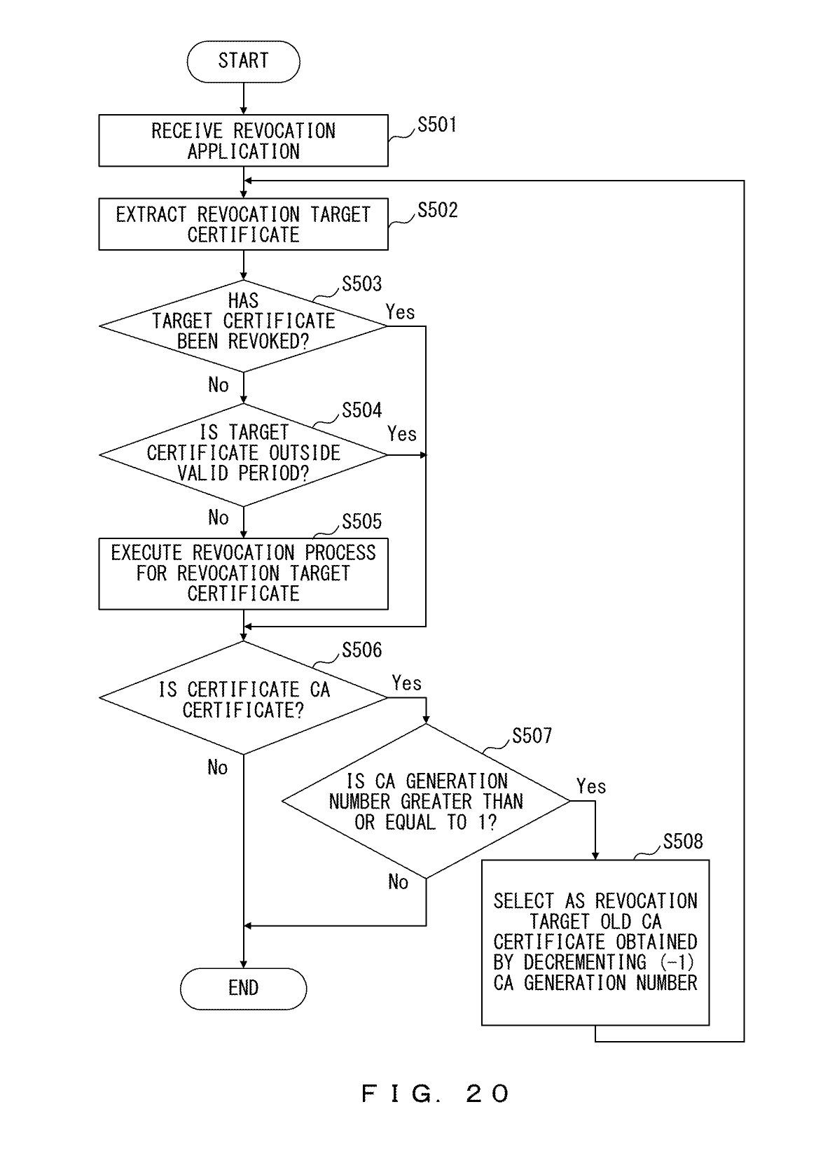

Next, the operation flow for the certificate revocation process will be described. FIG. 20 is an example of the flowchart illustrating details of the certificate revocation process. Note that in FIG. 20, the description will be made assuming that the initial value of “CA generation number” in certificate management information 32 is “0”.

In FIG. 20, first, the certificate revocation unit 26 receives a revocation application (S501). The revocation application is received, for example, from the RA and the CA manager. Then, the certificate revocation unit 26 recognizes as a target certificate the certificate for which the revocation application is specified in the revocation application. Note that, for example, the revocation application includes the serial number of the target certificate.

Then, the certificate revocation unit 26 extracts the target certificate from the certificate management information 32 (S502). Specifically, the certificate revocation unit 26 extracts the entry of the target certificate from the certificate management information 32. For example, in a case in which the serial number of the target certificate is specified in the revocation application, the certificate revocation unit 26 extracts the entry whose “serial number” is the same as the specified serial number from among the entries in the certificate management information 32.

Then, the certificate revocation unit 26 judges whether or not the target certificate has been revoked (S503). Specifically, the certificate revocation unit 26 judges whether or not the value of “revocation” of the entry that has been extracted in S502 is “true”. In a case in which it has been judged that the target certificate has been revoked, that is, that the value of “revocation” of the entry that has been extracted in S502 is “true” (Yes in S503), the process transitions to S506. In contrast, in a case in which it has been judged that the target certificate has not been revoked, that is, that the value of “revocation” of the entry that has been extracted in S502 is “false” (No in S503), the process transitions to S504.

In S504, the certificate revocation unit 26 judges whether or not the target certificate is outside the valid period (S504). Specifically, for example, the certificate revocation unit 26 judges whether or not the present date (process date in S504) is on or after “start date” of “valid period” of the entry that has been extracted in S502 and at the same time is on or before “expiration date” of the entry. In the case in which it has been judged that the target certificate is outside the valid period, that is, that the present date is before “start date” of the entry that has been extracted in S502 or after “expiration date” of the entry (Yes in S504), the process transitions to S506. In contrast, in the case in which it has been judged that the target certificate is within the valid period, that is, that the present date is on or after “start date” of the entry that has been extracted in S502 and at the same time on or before “expiration date” of the entry (No in S504), the process transitions to S505.

In S505, the certificate revocation unit 26 executes the revocation process of the target certificate (S505). Specifically, for example, the certificate revocation unit 26 sets “true” to “revocation” of the entry that has been extracted in S502, sets the present time (process time in S505) to “revocation date”, and sets a revocation reason to “revocation reason”.

Then, the certificate revocation unit 26 judges whether or not the target certificate is a CA certificate (S506). Specifically, for example, the certificate revocation unit 26 judges whether or not “certificate type” of the entry that has been extracted in S502 is “root CA” or “intermediate CA”. In a case in which it has been judged that the target certificate is not the CA certificate, that is, neither “root CA” nor “intermediate CA” (No in S506), the process is terminated. In contrast, in a case in which the target certificate is the CA certificate, that is, “certificate type” of the entry that has been extracted in S502 is “root CA” or “intermediate CA” (Yes in S506), the process transitions to S507.

In S507, the certificate revocation unit 26 judges whether or not the CA generation number of the target certificate is greater than or equal to 1 (S507). Specifically, for example, the certificate revocation unit 26 judges whether or not “CA generation number” of the entry that has been extracted in S502 is greater than or equal to “1”. In a case in which it has been judged that the CA generation number of the target certificate is less than 1, that is, “CA generation number” of the entry that has been extracted in S502 is less than “1” (No in S507), the process is terminated. In contrast, in a case in which it has been judged that the CA generation number of the target certificate is greater than or equal to 1, that is, “CA generation number” of the entry that has been extracted in S502 is greater than or equal to “1” (Yes in S507), the process transitions to S508.

In S508, the certificate revocation unit 26 recognizes as a new target certificate the old CA certificate that has been obtained by decrementing (−1) the CA generation number of the target certificate (S508). Then, the process transitions to S502, and the certificate revocation unit 26 extracts from the certificate management information 32 the target certificate that has been newly recognized in S508. That is, for example, the certificate revocation unit 26 extracts in the certificate management information 32 the entry whose “CA generation number” matches the value that is smaller by one than the CA generation number of the target certificate and whose “certificate type” is “root CA” or “intermediate CA”. Thereafter, the processes in S503 and subsequent steps will be executed.

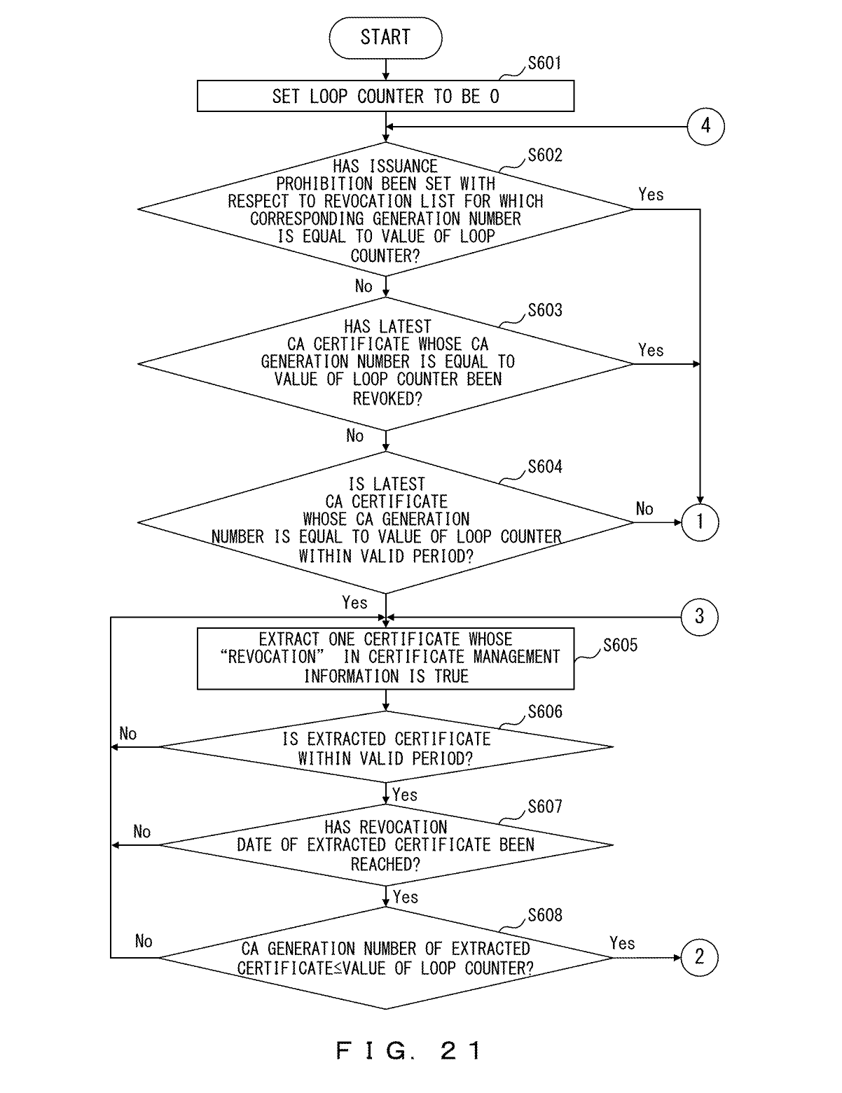

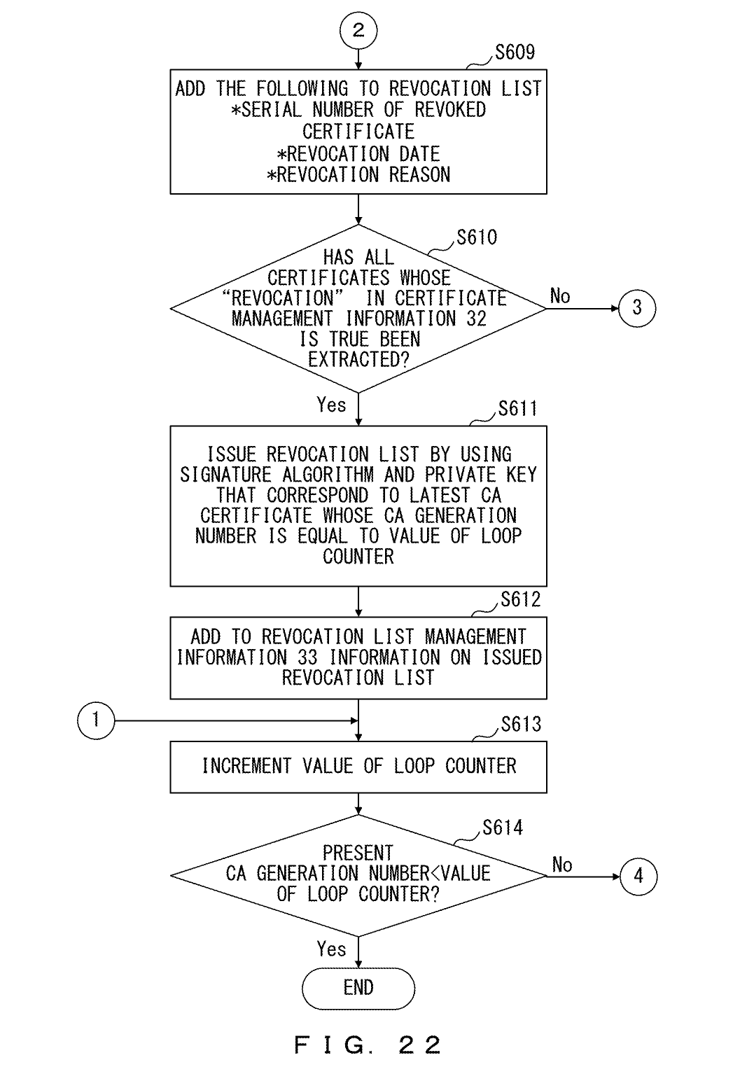

Next, the operation flow of the revocation list issuance process will be described with reference to FIGS. 21 and 22. FIG. 21 is an example of the flowchart (former part) illustrating details of the revocation list issuance process. FIG. 22 is an example of the flowchart (latter part) illustrating details of the revocation list issuance process.

In FIG. 21, the certificate revocation unit 26 first sets to “0” the value of a loop counter, which is a control variable (S601).

Next, the revocation list issuance unit 25 judges whether or not issuance prohibition is set for the revocation list in which the corresponding CA generation number is equal to the value of the loop counter (S602). That is, the revocation list issuance unit 25 judges whether or not “revocation list issuance permission” of the entry in the CA management information 31 whose “item number” is greatest among the entries whose “CA generation number” is equal to the value of the loop counter is “true”. In a case in which it has been judged that “revocation list issuance permission” of the entry in the CA management information 31 whose “item number” is greatest among the entries whose “CA generation number” is equal to the value of the loop counter is “false” (Yes in S602), the process transitions to S613 in FIG. 22. In contrast, in a case in which it has been judged that “revocation list issuance permission” of the entry in the CA management information 31 whose “item number” is greatest among the entries whose “CA generation number” is equal to the value of the loop counter is “true” (No in S602), the process transitions to S603.

In S603, the revocation list issuance unit 25 judges whether or not the latest CA certificate whose CA generation number is the same as the value of the loop counter has been revoked (S603). That is, the revocation list issuance unit 25 first refers to “item number in certificate management information” of the entry in the CA management information 31 whose “item number” is the greatest among the entries whose “CA generation number” is equal to the value of the loop counter. Then, the revocation list issuance unit 25 extracts in the certificate management information 32 the entry whose “item number” matches “item number in certificate management information” that has been referred to, and judges whether or not “revocation” of the extracted entry is “true”. In a case in which “revocation” of the extracted entry is “true”, the revocation list issuance unit 25 judges that the latest CA certificate whose CA generation number is equal to the value of the loop counter has been revoked. In contrast, in a case in which “revocation” of the extracted entry is “false”, the revocation list issuance unit 25 judges that the latest CA certificate whose CA generation number is equal to the value of the loop counter has not been revoked.

In S603, in a case in which it has been judged that the latest CA certificate whose CA generation number is equal to the value of the loop counter has been revoked (Yes in S603), the process transitions to S613 in FIG. 22. In contrast, in a case in which it has been judged that the latest CA certificate whose CA generation number is equal to the value of the loop counter has not been revoked (No in S603), the process transitions to S604.

In S604, the revocation list issuance unit 25 judges whether or not the latest CA certificate whose CA generation number is equal to the value of the loop counter is within the valid period (S604). That is, the revocation list issuance unit 25 first refers to “item number in certificate management information” of the entry in the CA management information 31 whose “item number” is greatest among the entries whose “CA generation number” is equal to the value of the loop counter. Next, the revocation list issuance unit 25 extracts in the certificate management information 32 the entry whose “item number” matches “item number in certificate management information” that has been referred to. Then, the revocation list issuance unit 25 judges whether or not the present date (process date in S604) is on or after “start date” of the extracted entry and at the same time on or before “expiration date” of the extracted entry. In a case in which the present date is on or after “start date” of the extracted entry and at the same time on or before “expiration date” of the extracted entry, the revocation list issuance unit 25 judges that the latest CA certificate whose CA generation number is equal to the value of the loop counter is within the valid period. In contrast, in a case in which the present date is before “start date” of the extracted entry or after “expiration date” of the extracted entry, the revocation list issuance unit 25 judges that the latest CA certificate whose CA generation number is equal to the value of the loop counter is outside the valid period.

In S604, in a case in which it has been judged that the latest CA certificate whose CA generation number is equal to the value of the loop counter is outside the valid period (No in S604), the process transitions to S613 in FIG. 22. In contrast, in a case in which it has been judged that the latest CA certificate whose CA generation number is equal to the value of the loop counter is within the valid period (Yes in S604), the process transitions to S605.

In S605, the revocation list issuance unit 25 extracts one entry whose “revocation” is “true” in the certificate management information 32 (S605).

Next, the revocation list issuance unit 25 judges whether or not the certificate of the entry that has been extracted in S605 is within the valid period (S606). That is, the revocation list issuance unit 25 judges whether or not the present date (process date in S606) is on or after “start date” of the entry that has been extracted in S605 and at the same time is on or before “expiration date” of the entry. In a case in which it has been judged that the certificate of the entry which has been extracted in S605 is outside the valid period (No in S606), the process transitions to S605. In contrast, in a case in which it has been judged that the certificate of the entry which has been extracted in S605 is within the valid period (Yes in S606), the process transitions to S607.

In S607, the revocation list issuance unit 25 judges whether or not the certificate of the entry that has been extracted in S605 has reached the revocation date. That is, the revocation list issuance unit 25 judges whether or not the present date (process date in S607) is on or after “revocation date” of the entry that has been extracted in S605. In a case in which it has been judged that the certificate of the entry that has been extracted in S605 has not reached the revocation date (No in S607), the process transitions to S605. In contrast, in a case in which it has been judged that the certificate of the entry that has been extracted in S605 has reached the revocation date (Yes in S607), the process transitions to S608.

In S608, the revocation list issuance unit 25 judges whether or not the CA generation number of the certificate of the entry that has been extracted in S605 is less than or equal to the value of the loop counter (S608). That is, the revocation list issuance unit 25 judges whether or not “CA generation number” of the entry that has been extracted in S605 is less than or equal to the value of the loop counter. In a case in which it has been judged that the CA generation number of the certificate of the entry that has been extracted in S605 is greater than the value of the loop counter (No in S608), the process transitions to S605. In contrast, in a case in which it has been judged that the CA generation number of the certificate of the entry that has been extracted in S605 is less than or equal to the value of the loop counter (Yes in S608), the process transitions to S609 in FIG. 22.

In S609, the revocation list issuance unit 25 adds information on the certificate of the entry that has been extracted in S605 as a list of invalid certificates that are included in the target revocation list (S609). Information on the certificate of the entry that has been extracted in S605, which is added to the target revocation list, includes for example values of “serial number”, “revocation date” and “revocation reason” of the entry.

Next, the revocation list issuance unit 25 judges whether or not all the entries whose “revocation” is “true” have been extracted in the certificate management information 32 (S610). In a case in which it has been judged that not all the entries whose “revocation” is “true” have been extracted in the certificate management information 32 (No in S610), the process transitions to S605 in FIG. 21. In contrast, in a case in which it has been judged that all the entries whose “revocation” is “true” have been extracted in the certificate management information 32 (Yes in S610), the process transitions to S611.

In S611, the revocation list issuance unit 25 specifies the latest CA certificate whose CA generation number is equal to the value of the loop counter. Then, the revocation list issuance unit 25 instructs the key management unit 24 to give to the target revocation list the electronic signature of the CA private key of the specified CA certificate by using the same signature algorithm as that of the specified CA certificate (S611).

Next, the revocation list issuance unit 25 adds information on the revocation list that has been issued in S611 to the revocation list management information 33 (S612).

Next, the revocation list issuance unit 25 increments the loop counter by one (S613).

Next, the revocation list issuance unit 25 judges whether or not the CA generation number of the CA certificate that has been issued most recently is smaller than the value of the loop counter (S614). That is, the revocation list issuance unit 25 judges that the value of “CA generation number” of the entry whose “item number” is greatest in the CA management information 31 is smaller than the value of the loop counter. In a case in which it has been judged that the CA generation number of the CA certificate that has been issued most recently is greater than or equal to the value of the loop counter (No in S614), the process transitions to S602 in FIG. 21. In contrast, in a case in which it has been judged that the CA generation number of the CA certificate that has been issued most recently is smaller than the value of the loop counter (Yes in S614), the process is terminated.

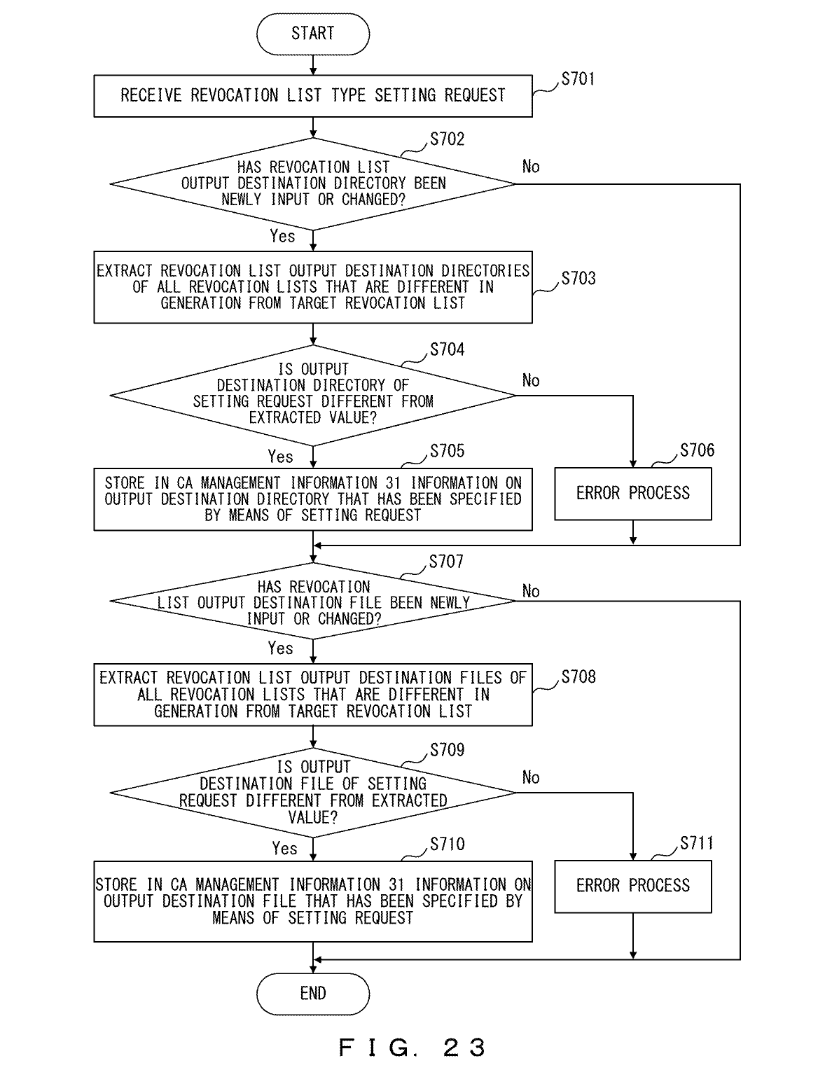

Next, the operation flow of the revocation list output destination overlap avoidance control will be described. FIG. 23 is an example of the flowchart illustrating details of the revocation list output destination overlap avoidance control.

In FIG. 23, the revocation list issuance unit 25 first receives a revocation list type setting request (S701). The setting request is input from the CA manager, for example, via the specified input and output device. Note that in FIG. 23, the revocation list that is a setting request target is referred to as a target revocation list.

Next, the revocation list issuance unit 25 judges whether or not the output destination directory on an LDAP directory server is newly input or changed in the revocation list type setting request (S702). In the case in which it has been judged that the output destination directory has neither been newly input nor changed in the revocation list type setting request (No in S702), the process transitions to S707. In contrast, in a case in which it has been judged that the output destination directory has been newly input or changed in the revocation list type setting request (Yes in S702), the process transitions to S703.

Next, the revocation list issuance unit 25 extracts the revocation list output destination directories of all the revocation lists that are different in generation from the target revocation list (S703). That is, the revocation list issuance unit 25 first selects all the entries whose “CA generation number” is different from the CA generation number of the target revocation list in the CA management information 31. Next, the revocation list issuance unit 25 extracts all the columns of the same revocation list type as the target revocation list type from among the “revocation list type setting” of the selected entries. Then, the revocation list issuance unit 25 extracts the values of “revocation list output destination directory” of setting data that has been set in all the selected columns.

Next, the revocation list issuance unit 25 judges whether or not the value of the output destination directory of the target revocation list is different from those of the revocation list output destination directories of all the revocation lists that are different in generation from the target revocation list (S704). That is, the revocation list issuance unit 25 judges whether or not the value of the output destination directory of the target revocation list is different from all the values of “revocation list output destination directory” that have been extracted in S703. In a casein which it has been judged that the value of the output destination directory of the target revocation list matches the revocation list output destination directory of a revocation list that is different in generation from the target revocation list (No in S704), the revocation list issuance unit 25 executes the error process (S706). In the error process, the revocation list issuance unit 25 executes a process for displaying, for example, via the specified output device to the CA manager a message to the effect that the specified output destination overlaps the output destination of the revocation list of another generation. Then, the process transitions to S707.

In contrast, in a case in which it has been judged that the value of the output destination directory of the target revocation list is different from all the revocation list output destination directories of the revocation lists that are different in generation from the target revocation list (Yes in S704), the revocation list issuance unit 25 executes the following process. That is, the revocation list issuance unit 25 stores in the CA management information 31 information on the output destination directory that has been specified by means of the setting request (S705). Specifically, the revocation list issuance unit 25 first selects the entry whose “CA generation number” matches the CA generation number of the target revocation list in the CA management information 31. Next, the revocation list issuance unit 25 extracts the column of the same revocation list type as the target revocation list type from among the “revocation list type setting” columns of the selected entry. Then, the revocation list issuance unit 25 sets the value of “revocation list output destination directory” of the setting data that has been set in the selected column in the output destination directory that has been specified in the setting request.

Next, the revocation list issuance unit 25 judges whether or not the output destination file on the local file system of a CA server has been newly input or changed in the revocation list type setting request (S707). In a case in which it has been judged that the output destination file has neither been newly input nor changed in the revocation list type setting request (No in S707), the process is terminated. In contrast, in a case in which it has been judged that the output destination file has been newly input or changed in the revocation list type setting request (Yes in S707), the process transitions to S708.

Next, the revocation list issuance unit 25 extracts the revocation list output destination files of all the revocation lists that are different in generation from the target revocation list (S708). That is, the revocation list issuance unit 25 first selects all the entries whose “CA generation number” is different from the CA generation number of the target revocation list in the CA management information 31. Next, the revocation list issuance unit 25 extracts all the columns of the same revocation list type as the target revocation list type from among the “revocation list type setting” columns of the selected entries. Then, the revocation list issuance unit 25 extracts values of “revocation list output destination file” of setting data that has been set in all the selected columns.

Next, the revocation list issuance unit 25 judges whether or not the value of the output destination file of the target revocation list is different from the revocation list output destination files of the all revocation lists that are different in generation from the target revocation list (S709). That is, the revocation list issuance unit 25 judges whether or not the value of the output destination file of the target revocation list is different from all the values of “revocation list output destination file” that have been extracted in S708. In a case in which it has been judged that the value of the output destination file of the target revocation list matches the revocation list output destination file of a revocation list that is different in generation from the target revocation list (No in S709), the revocation list issuance unit 25 executes the error process (S711). In the error process, the revocation list issuance unit 25 executes a process for displaying, for example, via the specified output device to the CA manager a message to the effect that the specified output destination overlaps the output destination of the revocation list of another generation. Then, the process is terminated.

In contrast, in S709, in a case in which it has been judged that the value of the output destination file of the target revocation list is different from all the values of the revocation list output destination files of the revocation lists that are different in generation from the target revocation list (Yes in S709), the revocation list issuance unit 25 executes the following process. That is, the revocation list issuance unit 25 stores in the CA management information 31 information on the output destination file that has been specified by means of the setting request (S710). Specifically, the revocation list issuance unit 25 first selects the entry whose “CA generation number” matches the CA generation number of the target revocation list in the CA management information 31. Next, the revocation list issuance unit 25 extracts the column of the same revocation list type as the target revocation list type from among the “revocation list type setting” columns of the selected entry. Then, the revocation list issuance unit 25 sets in the output destination file that has been specified in the setting request the value of “revocation list output destination file” of the setting data that has been set in the selected column. Then, the process is terminated.

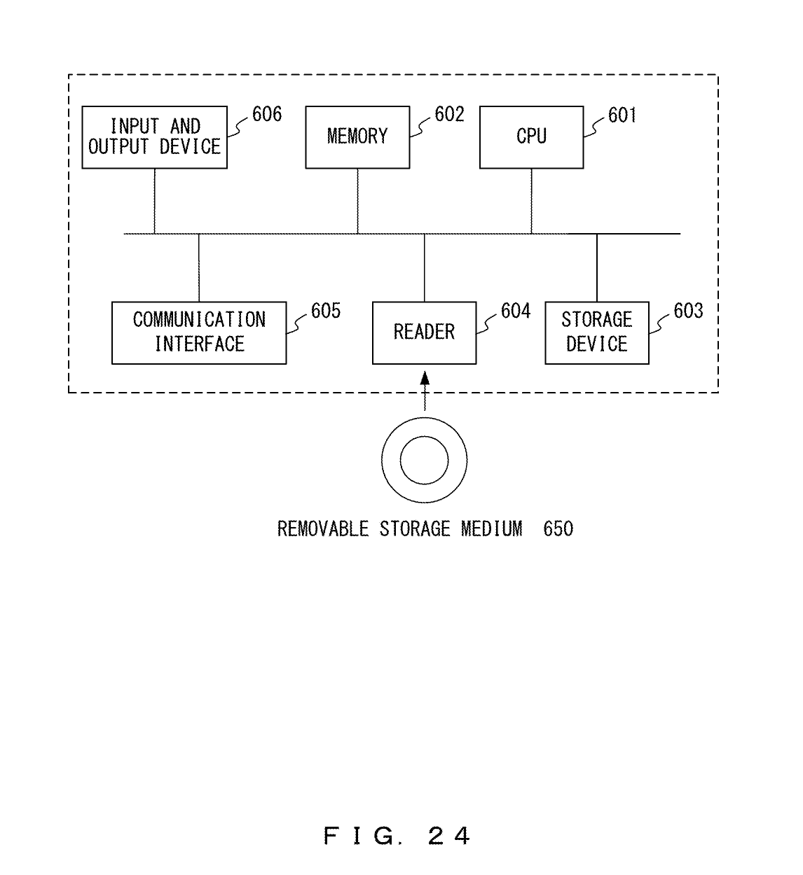

Next, hardware configuration of the CA operation apparatus 10 will be described. FIG. 24 illustrates hardware configuration of the CA operation apparatus according to the embodiment.

In FIG. 24, the CA operation apparatus 10 includes a CPU (Central Processing Unit) 601, a memory 602, a storage device 603, a reader 604, a communication interface 605, and the input and output device 606. The CPU 601, the memory 602, the storage device 603, the reader 604, the communication interface 605, and the input and output device 606 are connected with one another via a bus.

The CPU 601 provides functions of part of or all of the CA certificate issuance unit 22, the user certificate issuance unit 23, and the key management unit 24 by executing a program that describes procedures of the above flowchart by using the memory 602. The CPU 601 proves part of or all of the functions of the revocation list issuance unit 25, and the certificate revocation unit 26.

The memory 602 is, for example, a semiconductor memory and is configured by including a RAM (Random Access Memory) area and a ROM (Read Only Memory) area. The storage device 603 is, for example, a hard disk. Note that the storage device 603 may be a semiconductor memory such as a flash memory. In addition, the storage device 603 may be an external recording device. The storage device 603 provides part of or all of the functions of the storage unit 21 and the key management unit 24.

The reader 604 accesses a removable storage medium 650 according to instructions from the CPU 601. The removable storage medium 650 is realized, for example, by a semiconductor device (USB memory, etc.), a medium (magnetic disk, etc.) to and from which information is input and output due to magnetic action, or a medium (CD-ROM, DVD, etc.) to and from which information is input and output due to optical action. Note that the reader 604 may not be included in the CA operation apparatus 10.

The communication interface 605 communicates with the manager terminal 11 and the RA operation apparatus 12 via a network according to instructions from the CPU 601.

The input and output device 606 receives various instructions from the CA manager and displays error information, etc.

The program of the embodiment is provided to the CA operation apparatus 10, for example, in the following modes.

(1) installed in advance in the storage device 603
(2) provided by the removable storage medium 650
(3) provided via the communication interface 605 from a program server (not shown)

In addition, part of the CA operation apparatus 10 of the embodiment may be realized by hardware. Alternatively, the CA operation apparatus 10 of the embodiment may be realized by a combination of software and hardware.

In addition, the function of the key management unit 24 may be realized by the CPU of a device that is connected to the CA operation apparatus 10 via a network or a bus. The function of the key management unit 24 may be realized by hardware that is tamper-resistant against attacks from outside, or the CPU that is installed in the hardware. Specifically, for example, a function of the key management unit 24 may be realized by an HSM (Hardware Security Module) that is connected to the CA operation apparatus 10. A function of the storage unit 21 may be realized by an storage device that is connected to the CA operation apparatus 10.

In addition, in this embodiment, the CA private key and the public key that corresponds to the CA private key are stored as a set in the same storage area of the key management unit 24. It is not possible to take the private key out of the storage area, and an encryption and signing process is executed in a state in which the private key is retained in the storage area.

Note that the present embodiment is not limited to the embodiment that has been described above, and various configurations and embodiments can be taken within the scope not deviating from the spirit of the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A certificate authority operation apparatus comprising:
a storage unit that retains a plurality of private keys that correspond to a plurality of cryptosystems with different generations, respectively, encryption strength of each of the plurality of cryptosystems being different according with the generations; and
a processor which executes a process including:
when acquiring an issuance instruction, performing a control so as to issue a public key certificate by utilizing a first private key that corresponds to a cryptosystem of a generation whose encryption strength is highest.

2. The certificate authority operation apparatus according to claim 1, wherein
the performing performs a control so as to issue the public key certificate by utilizing the first private key that corresponds to a cryptosystem of a latest generation among the cryptosystems of the plurality of generations and so as not to issue a public key certificate by utilizing a second private key that is different from the first private key.

3. The certificate authority operation apparatus according to claim 1, the process further including:
issuing, by utilizing a private key from among the plurality of private keys, a revocation list that includes revocation information on a public key certificate that has been issued by utilizing the private key, and
stopping the issuance of a revocation list of the public key certificate that has been issued by utilizing the private key when acquiring an issuance stop request for the revocation information.

4. The certificate authority operation apparatus according to claim 1, wherein
a revocation list that has been generated by utilizing the cryptosystem of the generation whose encryption strength is highest includes revocation information on a public key certificate that has been issued by utilizing a cryptosystem of a generation that is different from the generation whose encryption strength is highest.

5. The certificate authority operation apparatus according to claim 1, wherein
the storage unit stores generation information that is obtained by associating information that indicates a generation of the cryptosystem with a public key certificate that has been generated by utilizing a cryptosystem of a generation that is indicated by the information that indicates the generation, and
the process further includes:
when a certificate authority certificate that is a public key certificate for ensuring legitimacy of the certificate authority operation apparatus has been revoked, revoking a certificate authority certificate that has been generated by utilizing a cryptosystem whose encryption strength is weaker than a cryptosystem that has been used for generating the revoked certificate authority certificate according to the generation information.

6. The certificate authority operation apparatus according to claim 1, wherein
the storage unit stores information that indicates each strength of the plurality of private keys, and
the process further includes:
when the first private key is generated, in a case in which a strength of the first private key is higher than strengths of any of private keys that are different from the first private key, performing a control so as to generate the first private key.

7. The certificate authority operation apparatus according to claim 3, wherein
the storage unit stores output destination information that indicates each output destination of the plurality of revocation lists, and
the process further includes:
when receiving a setting request that includes a first output destination that indicates an output destination of a first revocation list that is a revocation list among the plurality of revocation lists, setting as the first output destination the output destination of the first revocation list in a case in which the first output destination that is included in the received setting request is different from an output destination that is indicated by the output destination information of a revocation list whose generation is different from that of the first revocation list.

8. A non-transitory computer-readable recording medium having stored therein a certificate authority operating program that causes a computer to execute a process comprising:
when acquiring an issuance instruction, performing a control so as to issue a public key certificate by utilizing a private key that corresponds to a cryptosystem of a generation whose encryption strength is highest among a plurality of private keys that correspond to a plurality of cryptosystems with different generations, respectively, encryption strengths of each of the plurality of cryptosystems being different according with the generations.

9. A certificate authority operation method comprising:
when acquiring an issuance instruction, performing a control, by using a computer, so as to issue a public key certificate by utilizing a private key that corresponds to a cryptosystem of a generation whose encryption strength is highest among a plurality of private keys that correspond to a plurality of cryptosystems with different generations, respectively, encryption strengths of each of the plurality of cryptosystems being different according with the generations.
